(19) United States
(12) Patent Application Publication
(10) Pub. No.: US 2026/0355700 A1
(43) Pub. Date: Nov. 12, 2026

(54) POLYGUANIDINE-CONTAINING MEMBRANES AND METHODS OF USING THEREOF

(71) Applicant: Ohio State Innovation Foundation, Columbus, OH (US)

(72) Inventors: W.S. Winston Ho, Columbus, OH (US); Yang HAN, Columbus, OH (US); Jingying HU, Columbus, OH (US)

(21) Appl. No.: 19/110,873

(22) PCT Filed: Sep. 12, 2023
(86) PCT No.: PCT/US2023/032480

§ 371 Date: Mar. 12, 2025

Related U.S. Application Data
(60) Provisional application No. 63/405,825, filed on Sep. 12, 2022.

(51) Int. Cl. B01D 71/58; B01D 53/22; B01D 69/10; B01D 69/14; B01D 71/02

(52) U.S. Cl. CPC B01D 71/58; B01D 53/228; B01D 69/107; B01D 69/14111; B01D 71/0212; B01D 2256/22; B01D 2257/102

(57) ABSTRACT

Membranes, methods of making the membranes, and methods of using the membranes are described herein. The membrane can comprise a support layer; and a selective polymer layer disposed (e.g., coated) on the support layer. The selective polymer layer can comprise a polymer matrix comprising a polyguanidine polymer. Optionally, the polymer matrix can further comprise a hydrophilic polymer, an amine-containing polymer, or a combination thereof. In some embodiments, the selective polymer layer can further comprise a mobile carrier (e.g., a guanidine-based mobile carrier, an amine-based mobile carrier, or a combination thereof) dispersed within the polymer matrix. Optionally, the selective polymer later can further include a CO₂-philic ether, a graphene oxide, carbon nanotubes, or a combination thereof, dispersed within the polymer matrix. The membranes can be used to separate carbon dioxide from other gases, such as hydrogen and/or nitrogen. Also provided are methods of separating gas streams using the membranes described herein.

### CROSS-REFERENCE TO RELATED APPLICATIONS

This application claims benefit of U.S. Provisional Application No. 63/405,825, filed Sep. 12, 2022, which is hereby incorporated herein by reference in its entirety.

### STATEMENT REGARDING FEDERALLY SPONSORED RESEARCH OR DEVELOPMENT

This invention was made with government support under grant/contract number DE-FE0031731 awarded by the Department of Energy. The government has certain rights in the invention.

### BACKGROUND

There has been growing concern about global warming since the CO₂ concentration in the atmosphere has surpassed 400 ppm in the past decade. The combustion of fossil fuels is one of the major contributors to the large amount of CO₂ emissions. A variety of strategies for addressing CO₂ emissions have been suggested. For example, membranes technologies have been suggested as a promising approach to capture CO₂ from large stationary sources. Once captured, the CO₂ could be compressed and geologically sequestered. However, improved membranes for the separation of CO₂ are needed to successfully implement these solutions.

### SUMMARY

Disclosed are membranes that comprise a support layer; and a selective polymer layer disposed (e.g., coated) on the support layer. The selective polymer layer can comprise a polymer matrix that comprises a polyguanidine polymer.

In some examples, the polyguanidine polymer can be chosen from polyethylene guanidine, polytrimethylene guanidine, polytetramethylene guanidine, polypentamethylene guanidine, polyhexamethylene guanidine, polyheptamethylene guanidine, polyoctamethylene guanidine, polyethylene N-methylguanidine, polytrimethylene N-methylguanidine, polytetramethylene N-methylguanidine, polypentamethylene N-methylguanidine, polyhexamethylene N-methylguanidine, polyheptamethylene N-methylguanidine, polyoctamethylene N-methylguanidine, polyethylene N,N′-dimethylguanidine, polytrimethylene N,N′-dimethylguanidine, polytetramethylene N,N′-dimethylguanidine, polypentamethylene N,N′-dimethylguanidine, polyhexamethylene N,N′-dimethylguanidine, polyheptamethylene N,N′-dimethylguanidine, polyoctamethylene N,N′-dimethylguanidine, poly(N-vinylguanidine), poly(N-allylguanidine), poly(N-butylguanidine), poly(N-pentylguanidine), poly(N-hexylguanidine), poly(N-heptylguanidine), poly(N-octylguanidine), copolymers thereof, and blends thereof. In certain embodiments, the polyguanidine polymer can comprise polyethylene guanidine (PEG).

In some embodiments, the polyguanidine polymer can be present in the selective polymer layer in an amount of from 10% to 70% by weight, based on the total dry weight of the selective polymer layer.

Optionally, the polymer matrix can further comprise a hydrophilic polymer, an amine-containing polymer, or a combination thereof.

In some examples, the amine-containing polymer is selected from the group consisting of polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof. In certain embodiments, the amine-containing polymer comprises polyvinylamine.

In some examples, the hydrophilic polymer can comprise a polymer selected from the group consisting of polyvinylalcohol, polyvinylacetate, polyethylene oxide, polyvinylpyrrolidone, polyacrylamine, a polyamine such as polyallylamine, polyvinyl amine, or polyethylenimine, polysiloxane, copolymers thereof, and blends thereof.

Optionally, the selective polymer layer further comprises a mobile carrier dispersed within the polymer matrix. The mobile carrier can comprise a guanidine-based mobile carrier, an amine-containing mobile carrier, or a combination thereof. In some embodiments, the mobile carrier can have a molecular weight of less than 1,000 Da.

In some examples, the mobile carrier can be selected from 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, amidine with the structure R₄—(C═NH)—NR₂R₃ where each of R₁, R₂, and R₃ groups being H or R=CₙH₂ₙ₊₁ with n ranging from 1 to 10, guanidine with the structure R₁—N(R₂)—(C═NH)—N R₃R₄ where each of R₁, R₂, R₃, and R₄ groups being H or R=CₙH₂ₙ₊₁ with n ranging from 1 to 10, and combinations thereof.

Optionally, the selective polymer layer further comprises a CO₂-philic ether, a cross-linking agent, graphene oxide, carbon nanotubes, or a combination thereof.

In some embodiments, the support layer can comprise a gas permeable polymer, such as a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

In some embodiments, the support layer can comprise a gas permeable polymer disposed on a base. The base can comprise a non-woven fabric, such as a non-woven fabric comprising fibers formed from a polyester.

The membrane can be configured in a flat sheet, a spiral-wound (SW), a hollow fiber, or a plate-and-frame configuration.

In some embodiments, the membrane can be selectively permeable to an acidic gas. For example, the membrane is selectively permeable to a fluid selected from the group consisting of carbon dioxide, hydrogen sulfide, sulfur dioxide, sulfur trioxide, nitrogen oxide, hydrogen chloride, water, and combinations thereof.

In some embodiments, the selective polymer layer can have a CO₂:N₂ selectivity of at least 50 at 57 °C and 4 bar feed pressure (e.g., a CO₂:N₂ selectivity of from 50 to 500 at 57 °C and 4 bar feed pressure, from 50 to 350 at 57 °C and 4 bar feed pressure, from 100 to 500 at 57 °C and 4 bar feed pressure, or from 100 to 350 at 57 °C and 4 bar feed pressure).

Also described herein are methods for separating a first gas from a feed gas stream. These methods can comprise contacting a membrane described herein with the feed gas stream comprising the first gas under conditions effective to afford transmembrane permeation of the first gas.

### DESCRIPTION OF DRAWINGS

FIG. 1 shows the chemical structures of PVAm, PZEA-Sar, and PZC.

FIG. 2 shows a 400 MHz ¹³C NMR spectrum of PEG obtained using D₂O as the solvent.

FIG. 3 is a plot showing the IR spectrum of PEG.

FIG. 4 is a plot showing the CO₂/N₂ separation performance of membranes containing 20 wt. % PZEA-Sar, 20 wt. % PZC, and various contents of PEG with balance of PVAm.

FIG. 5 is a plot showing the CO₂/N₂ separation performance of membranes containing 6 wt. % PVAm, 40-70 wt. % PZEA-Sar, and balance of PEG.

FIG. 6A is a diagram showing design of a crossflow SW element.

FIG. 6B is a schematic diagram of an open layout of the center tube and the glue pattern in a membrane leaf. The epoxy glue line is labeled.

FIG. 7 is a plot showing the CO₂ permeance and CO₂/N₂ selectivity of the commercial-size 8-inch diameter prototype SW module with the polyguanidine-containing membrane using a simulated flue gas at 77 °C. \textcircled{1}=Simulated flue gas (20% CO₂); \textcircled{2}=Simulated NGCC flue gas (4.1% CO₂); \textcircled{3}=Simulated coal flue gas (13% CO₂).

FIG. 8A is a photograph showing the coal-fired boiler at the Center for Applied Energy Research (CAER) at the University of Kentucky.

FIG. 8B is a photograph showing membrane testing unit.

FIG. 9 is a plot showing the CO₂ permeance and CO₂/N₂ selectivity of the commercial-size 8-inch diameter prototype SW module with the polyguanidine-containing membrane using an actual flue gas at 77 °C.

FIG. 10 is a piping and instrumentation diagram (P&ID) of the integrated bench skid.

FIG. 11A is a diagram showing the design of a countercurrent SW element for the use of retentate recycle as sweep gas.

FIG. 11B is a schematic diagram of an open layout of the center tube and the glue pattern in a membrane leaf.

FIG. 12A is a photo showing the front-view and side-view of the Stage 1 Module.

FIG. 12B is a photo showing the front-view and side-view of the Stage 2 Module.

FIG. 13 is a photo showing the integrated bench skid.

FIG. 14 is a plot showing the CO₂ capture degree and CO₂ purity from the 500-h bench skid testing with simulated coal flue gas.

### DETAILED DESCRIPTION

Disclosed herein are membranes that comprise a support layer; and a selective polymer layer disposed (e.g., coated) on the support layer. The selective polymer layer can comprise a polymer matrix comprising a polyguanidine polymer.

Also provided are methods of making these membranes, and methods of using these membranes.

### DEFINITIONS

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings.

“Optional” or “optionally” means that the subsequently described event or circumstance may or may not occur, and that the description includes instances where said event or circumstance occurs and instances where it does not.

The term “n-membered” where n is an integer typically describes the number of ring-forming atoms in a moiety where the number of ring-forming atoms is n. For example, piperidinyl is an example of a 6-membered heterocycloalkyl ring, pyrazolyl is an example of a 5-membered heteroaryl ring, pyridyl is an example of a 6-membered heteroaryl ring, and 1,2,3,4-tetrahydro-naphthalene is an example of a 10-membered cycloalkyl group.

As used herein, the phrase “optionally substituted” means unsubstituted or substituted. As used herein, the term “substituted” means that a hydrogen atom is removed and replaced by a substituent. It is to be understood that substitution at a given atom is limited by valency.

Throughout the definitions, the term “Cₙ₋ₘ” indicates a range which includes the endpoints, wherein n and m are integers and indicate the number of carbons. Examples include C₁₋₄, C₁₋₆, and the like.

As used herein, the term “Cₙ₋ₘ alkyl”, employed alone or in combination with other terms, refers to a saturated hydrocarbon group that may be straight-chain or branched, having n to m carbons. Examples of alkyl moieties include, but are not limited to, chemical groups such as methyl, ethyl, n-propyl, isopropyl, i-butyl, tert-butyl, isobutyl, sec-butyl; higher homologs such as 2-methyl-1-butyl, n-pentyl, 3-pentyl, n-hexyl, 1,2,2-trimethylpropyl, and the like. In some embodiments, the alkyl group contains from 1 to 6 carbon atoms, from 1 to 4 carbon atoms, from 1 to 3 carbon atoms, or 1 to 2 carbon atoms.

As used herein, “Cₙ₋ₘ alkenyl” refers to an alkyl group having one or more double carbon-carbon bonds and having n to m carbons. Example alkenyl groups include, but are not limited to, ethenyl, n-propenyl, isopropenyl, n-butenyl, sec-butenyl, and the like. In some embodiments, the alkenyl moiety contains 2 to 6, 2 to 4, or 2 to 3 carbon atoms.

As used herein, “Cₙ₋ₘ alkynyl” refers to an alkyl group having one or more triple carbon-carbon bonds and having n to m carbons. Example alkynyl groups include, but are not limited to, ethynyl, propyn-1-yl, propyn-2-yl, and the like. In some embodiments, the alkynyl moiety contains 2 to 6, 2 to 4, or 2 to 3 carbon atoms.

As used herein, the term “Cₙ₋ₘ alkylene”, employed alone or in combination with other terms, refers to a divalent alkyl linking group having n to m carbons. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like.

In some embodiments, the alkylene moiety contains 2 to 6, 2 to 4, 2 to 3, 1 to 6, 1 to 4, or 1 to 2 carbon atoms.

As used herein, the term “Ca-m alkoxy”, employed alone or in combination with other terms, refers to a group of formula —O-alkyl, wherein the alkyl group has n to m carbons. Example alkoxy groups include methoxy, ethoxy, propoxy (e.g., n-propoxy and isopropoxy), tert-butoxy, and the like. In some embodiments, the alkyl group has 1 to 6, 1 to 4, or 1 to 3 carbon atoms.

As used herein, the term “Cₙ₋ₘ alkylamino” refers to a group of formula —NH(alkyl), wherein the alkyl group has n to m carbon atoms. In some embodiments, the alkyl group has 1 to 6, 1 to 4, or 1 to 3 carbon atoms.

As used herein, the term “Cₙ₋ₘ alkoxycarbonyl” refers to a group of formula —C(O)O-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylcarbonyl” refers to a group of formula —C(O)— alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylcarbonylamino” refers to a group of formula —NHC(O)-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylsulfonylamino” refers to a group of formula —NHS(O)₂-alkyl, wherein the alkyl group has n to m carbon atoms. In some embodiments, the alkyl group has 1 to 6, 1 to 4, or 1 to 3 carbon atoms.

As used herein, the term “aminosulfonyl” refers to a group of formula —S(O)₂NH₂.

As used herein, the term “Cₙ₋ₘ alkylaminosulfonyl” refers to a group of formula —S(O)₂NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminosulfonyl” refers to a group of formula —S(O)₂N(alkyl)₂, wherein each alkyl group independently has n to m carbon atoms. In some embodiments, each alkyl group has, independently, 1 to 6, 1 to 4, or 1 to 3 carbon atoms.

As used herein, the term “aminosulfonylamino” refers to a group of formula —NHS(O)₂NH₂.

As used herein, the term “Cₙ₋ₘ alkylaminosulfonylamino” refers to a group of formula —NHS(O)₂NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminosulfonylamino” refers to a group of formula —NHS(O)₂N(alkyl)₂, wherein each alkyl group independently has n to m carbon atoms. In some embodiments, each alkyl group has, independently, 1 to 6, 1 to 4, or 1 to 3 carbon atoms.

As used herein, the term “aminocarbonylamino”, employed alone or in combination with other terms, refers to a group of formula —NHC(O)NH₂.

As used herein, the term “Cₙ₋ₘ alkylaminocarbonylamino” refers to a group of formula —NHC(O)NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminocarbonylamino” refers to a group of formula —NHC(O)N(alkyl)₂, wherein each alkyl group independently has n to m carbon atoms. In some embodiments, each alkyl group has, independently, 1 to 6, 1 to 4, or 1 to 3 carbon atoms.

As used herein, the term “Cₙ₋ₘ alkylcarbamyl” refers to a group of formula —C(O)—NH(alkyl), wherein the alkyl group has n to m carbon atoms. In some embodiments, the alkyl group has 1 to 6, 1 to 4, or 1 to 3 carbon atoms.

As used herein, the term “thio” refers to a group of formula —SH.

As used herein, the term “Cₙ₋ₘ alkylsulfinyl” refers to a group of formula —S(O)— alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylsulfonyl” refers to a group of formula —S(O)₂-alkyl, wherein the alkyl group has n to m carbon atoms. In some embodiments, the alkyl group has 1 to 6, 1 to 4, or 1 to 3 carbon atoms.

As used herein, the term “amino” refers to a group of formula —NH₂.

As used herein, the term “aryl,” employed alone or in combination with other terms, refers to an aromatic hydrocarbon group, which may be monocyclic or polycyclic (e.g., having 2, 3 or 4 fused rings). The term “Cₙ₋ₘ aryl” refers to an aryl group having from n to m ring carbon atoms. Aryl groups include, e.g., phenyl, naphthyl, anthracenyl, phenanthrenyl, indanyl, indenyl, and the like. In some embodiments, aryl groups have from 6 to about 20 carbon atoms, from 6 to about 15 carbon atoms, or from 6 to about 10 carbon atoms. In some embodiments, the aryl group is a substituted or unsubstituted phenyl.

As used herein, the term “carbamyl” to a group of formula —C(O)NH₂.

As used herein, the term “carbonyl”, employed alone or in combination with other terms, refers to a —C(═O)— group, which may also be written as C(O).

As used herein, the term “di(Cₙ₋ₘ-alkyl)amino” refers to a group of formula —N(alkyl)₂, wherein the two alkyl groups each has, independently, n to m carbon atoms. In some embodiments, each alkyl group independently has 1 to 6, 1 to 4, or 1 to 3 carbon atoms.

As used herein, the term “di(Cₙ₋ₘ-alkyl)carbamyl” refers to a group of formula —C(O)N(alkyl)₂, wherein the two alkyl groups each has, independently, n to m carbon atoms.

In some embodiments, each alkyl group independently has 1 to 6, 1 to 4, or 1 to 3 carbon atoms.

As used herein, the term “halo” refers to F, Cl, Br, or I. In some embodiments, a halo is F, Cl, or Br. In some embodiments, a halo is F or Cl.

As used herein, “Cₙ₋ₘ haloalkoxy” refers to a group of formula —O-haloalkyl having n to m carbon atoms. An example haloalkoxy group is OCF₃. In some embodiments, the haloalkoxy group is fluorinated only. In some embodiments, the alkyl group has 1 to 6, 1 to 4, or 1 to 3 carbon atoms.

As used herein, the term “Cₙ₋ₘ haloalkyl”, employed alone or in combination with other terms, refers to an alkyl group having from one halogen atom to 2s+1 halogen atoms which may be the same or different, where “s” is the number of carbon atoms in the alkyl group, wherein the alkyl group has n to m carbon atoms. In some embodiments, the haloalkyl group is fluorinated only. In some embodiments, the alkyl group has 1 to 6, 1 to 4, or 1 to 3 carbon atoms.

As used herein, “cycloalkyl” refers to non-aromatic cyclic hydrocarbons including cyclized alkyl and/or alkenyl groups. Cycloalkyl groups can include mono- or polycyclic (e.g., having 2, 3 or 4 fused rings) groups and spirocycles. Cycloalkyl groups can have 3, 4, 5, 6, 7, 8, 9, or 10 ring-forming carbons (C₃₋₁₀). Ring-forming carbon atoms of a cycloalkyl group can be optionally substituted by oxo or sulfido (e.g., C(O) or C(S)). Cycloalkyl groups also include cycloalkylidenes. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, and the like. In some embodiments, cycloalkyl is cyclopropyl, cyclobutyl, cyclopentyl, cyclohexyl, cyclopentyl, or adamantyl. In some embodiments, the cycloalkyl has 6-10 ring-forming carbon atoms.

In some embodiments, cycloalkyl is adamantyl. Also included in the definition of cycloalkyl are moieties that have one or more aromatic rings fused (i.e., having a bond in common with) to the cycloalkyl ring, for example, benzo or thienyl derivatives of cyclopentane, cyclohexane, and the like. A cycloalkyl group containing a fused aromatic ring can be attached through any ring-forming atom including a ring-forming atom of the fused aromatic ring.

As used herein, “heteroaryl” refers to a monocyclic or polycyclic aromatic heterocycle having at least one heteroatom ring member selected from sulfur, oxygen, and nitrogen. In some embodiments, the heteroaryl ring has 1, 2, 3, or 4 heteroatom ring members independently selected from nitrogen, sulfur and oxygen. In some embodiments, any ring-forming N in a heteroaryl moiety can be an N-oxide. In some embodiments, the heteroaryl has 5-10 ring atoms and 1, 2, 3 or 4 heteroatom ring members independently selected from nitrogen, sulfur and oxygen. In some embodiments, the heteroaryl has 5-6 ring atoms and 1 or 2 heteroatom ring members independently selected from nitrogen, sulfur and oxygen. In some embodiments, the heteroaryl is a five-membered or six-membered heteroaryl ring. A five-membered heteroaryl ring is a heteroaryl with a ring having five ring atoms wherein one or more (e.g., 1, 2, or 3) ring atoms are independently selected from N, O, and S. Exemplary five-membered ring heteroaryls are thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4-oxadiazolyl. A six-membered heteroaryl ring is a heteroaryl with a ring having six ring atoms wherein one or more (e.g., 1, 2, or 3) ring atoms are independently selected from N, O, and S. Exemplary six-membered ring heteroaryls are pyridyl, pyrazinyl, pyrimidinyl, triazinyl and pyridazinyl.

As used herein, “heterocycloalkyl” refers to non-aromatic monocyclic or polycyclic heterocycles having one or more ring-forming heteroatoms selected from O, N, or S. Included in heterocycloalkyl are monocyclic 4-, 5-, 6-, and 7-membered heterocycloalkyl groups. Heterocycloalkyl groups can also include spirocycles. Example heterocycloalkyl groups include pyrrolidin-2-one, 1,3-isoxazolidin-2-one, pyranyl, tetrahydropuran, oxetanyl, azetidinyl, morpholino, thiomorpholino, piperazinyl, tetrahydrofuranyl, tetrahydrothienyl, piperidinyl, pyrrolidinyl, isoxazolidinyl, isothiazolidinyl, pyrazolidinyl, oxazolidinyl, thiazolidinyl, imidazolidinyl, azepanyl, benzazapene, and the like. Ring-forming carbon atoms and heteroatoms of a heterocycloalkyl group can be optionally substituted by oxo or sulfido (e.g., C(O), S(O), C(S), or S(O)₂, etc.). The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the cycloalkyl ring, for example, benzo or thienyl derivatives of piperidine, morpholine, azepine, etc. A heterocycloalkyl group containing a fused aromatic ring can be attached through any ring-forming atom including a ring-forming atom of the fused aromatic ring. In some embodiments, the heterocycloalkyl has 4-10, 4-7 or 4-6 ring atoms with 1 or 2 heteroatoms independently selected from nitrogen, oxygen, or sulfur and having one or more oxidized ring members.

At certain places, the definitions or embodiments refer to specific rings (e.g., an azetidine ring, a pyridine ring, etc.). Unless otherwise indicated, these rings can be attached to any ring member provided that the valency of the atom is not exceeded. For example, an azetidine ring may be attached at any position of the ring, whereas a pyridin-3-yl ring is attached at the 3-position.

The term “compound” as used herein is meant to include all stereoisomers, geometric isomers, tautomers, and isotopes of the structures depicted. Compounds herein identified by name or structure as one particular tautomeric form are intended to include other tautomeric forms unless otherwise specified.

Compounds provided herein also include tautomeric forms. Tautomeric forms result from the swapping of a single bond with an adjacent double bond together with the concomitant migration of a proton. Tautomeric forms include prototropic tautomers which are isomeric protonation states having the same empirical formula and total charge. Example prototropic tautomers include ketone-enol pairs, amide-imidic acid pairs, lactam-lactim pairs, enamine-imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

In some embodiments, the compounds described herein can contain one or more asymmetric centers and thus occur as racemates and racemic mixtures, enantiomerically enriched mixtures, single enantiomers, individual diastereomers and diastereomeric mixtures (e.g., including (R)- and (S)-enantiomers, diastereomers, (D)-isomers, (L)-isomers, (+) (dextrorotatory) forms, (−) (levorotatory) forms, the racemic mixtures thereof, and other mixtures thereof). Additional asymmetric carbon atoms can be present in a substituent, such as an alkyl group. All such isomeric forms, as well as mixtures thereof, of these compounds are expressly included in the present description. The compounds described herein can also or further contain linkages wherein bond rotation is restricted about that particular linkage, e.g., restriction resulting from the presence of a ring or double bond (e.g., carbon-carbon bonds, carbon-nitrogen bonds such as amide bonds). Accordingly, all cistrans and E/Z isomers and rotational isomers are expressly included in the present description. Unless otherwise mentioned or indicated, the chemical designation of a compound encompasses the mixture of all possible stereochemically isomeric forms of that compound.

Optical isomers can be obtained in pure form by standard procedures known to those skilled in the art, and include, but are not limited to, diastereomeric salt formation, kinetic resolution, and asymmetric synthesis. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, IN 1972), each of which is incorporated herein by reference in their entireties. It is also understood that the compounds described herein include all possible regioisomers, and mixtures thereof, which can be obtained in pure form by standard separation procedures known to those skilled in the art, and include, but are not limited to, column chromatography, thin-layer chromatography, and high-performance liquid chromatography.

### Membranes

The membranes described herein can comprise a support layer; and a selective polymer layer disposed (e.g., coated) on the support layer. The selective polymer layer can comprise a polymer matrix comprising a polyguanidine polymer. Optionally, the polymer matrix can further comprise a hydrophilic polymer, an amine-containing polymer, or a combination thereof. In some embodiments, the selective polymer layer can further comprise a mobile carrier (e.g., a guanidine-based mobile carrier, an amine-based mobile carrier, or a combination thereof) dispersed within the polymer matrix. Optionally, the selective polymer later can further include a CO₂-philic ether, a graphene oxide, carbon nanotubes, or a combination thereof, dispersed within the polymer matrix.

### Support Layer

The support layer can be formed from any suitable material. The material used to form the support layer can be chosen based on the end use application of the membrane. In some embodiments, the support layer can comprise a gas permeable polymer. The gas permeable polymer can be a cross-linked polymer, a phase separated polymer, a porous condensed polymer, or a blend thereof. Examples of suitable gas permeable polymers include polyamides, polyimides, polypyrrolones, polyesters, sulfone-based polymers, nitrile-based polymers, polymeric organosilicones, fluorinated polymers, polyolefins, copolymers thereof, or blends thereof. Specific examples of polymers that can be present in the support layer include polydimethylsiloxane, polydiethylsiloxane, polydi-iso-propylsiloxane, polydiphenylsiloxane, polyethersulfone, polyphenylsulfone, polysulfone, polyacrylonitrile, polyvinylidene fluoride, polyamide, polyimide, polyetherimide, polyetheretherketone, polyphenylene oxide, polybenzimidazole, polypropylene, polyethylene, partially fluorinated, perfluorinated or sulfonated derivatives thereof, copolymers thereof, or blends thereof. In some embodiments, the gas permeable polymer can be polysulfone or polyethersulfone. If desired, the support layer can include inorganic particles to increase the mechanical strength without altering the permeability of the support layer.

In certain embodiments, the support layer can comprise a gas permeable polymer disposed on a base. The base can be in any configuration configured to facilitate formation of a membrane suitable for use in a particular application. For example, the base can be a flat disk, a tube, a spiral wound, or a hollow fiber base. The base can be formed from any suitable material. In some embodiments, the layer can include a fibrous material. The fibrous material in the base can be a mesh (e.g., a metal or polymer mesh), a woven or non-woven fabric, a glass, fiberglass, a resin, a screen (e.g., a metal or polymer screen). In certain embodiments, the base can include a non-woven fabric (e.g., a non-woven fabric comprising fibers formed from a polyester).

### Selective Polymer Layer

The selective polymer layer can comprise a polymer matrix comprising a polyguanidine polymer. Optionally, the polymer matrix can further comprise a hydrophilic polymer, an amine-containing polymer, or a combination thereof. In some embodiments, the selective polymer layer can further comprise a mobile carrier (e.g., a guanidine-based mobile carrier, an amine-based mobile carrier, or a combination thereof) dispersed within the polymer matrix. Optionally, the selective polymer later can further include a CO₂-philic ether, a graphene oxide, carbon nanotubes, or a combination thereof, dispersed within the polymer matrix.

In some cases, the selective polymer layer can be a polymer matrix through which gas permeates via diffusion or facilitated diffusion. The selective polymer layer can comprise a polymer matrix having a CO₂:N₂ selectivity of at least 10 at 57 °C and 4 bar feed pressure. For example, the polymer matrix can have a CO₂:N₂ selectivity of at least 25 (e.g., at least 50, at least 75, at least 100, at least 125, at least 150, at least 175, at least 200, at least 225, at least 250, at least 275, at least 300, at least 325, at least 350, at least 375, at least 400, at least 425, at least 450, or at least 475) at 57 °C and 4 bar feed pressure. In some embodiments, the polymer matrix can have a CO₂:N₂ selectivity of 500 or less (e.g., 475 or less, 450 or less, 425 or less, 400 or less, 375 or less, 350 or less, 325 or less, 300 or less, 275 or less, 250 or less, 225 or less, 200 or less, 175 or less, 150 or less, 125 or less, 100 or less, 75 or less, 50 or less, or 25 or less) at 57 °C and 4 bar feed pressure.

In certain embodiments, the selective polymer layer can comprise a polymer matrix that has a CO₂:N₂ selectivity ranging from any of the minimum values described above to any of the maximum values described above. For example, in certain embodiments, the selective polymer layer can comprise a polymer matrix that has a CO₂:N₂ selectivity of from 10 to 500 at 57 °C and 4 bar feed pressure (e.g., from 10 to 400 at 57 °C and 4 bar feed pressure, from 75 to 400 at 57 °C and 4 bar feed pressure, from 100 to 400 at 57 °C and 4 bar feed pressure, from 10 to 350 at 57 °C and 4 bar feed pressure, from 75 to 350 at 57 °C and 4 bar feed pressure, from 100 to 350 at 57 °C and 4 bar feed pressure, from 10 to 250 at 57 °C and 4 bar feed pressure, from 75 to 250 at 57 °C and 4 bar feed pressure, or from 100 to 250 at 57 °C and 4 bar feed pressure). The CO₂:N₂ selectivity of the selective polymer can be measured using standard methods for measuring gas permeance known in the art, such as those described in the examples below.

### Polymer Matrix

The polymer matrix can comprise a polyguanidine polymer. Optionally, the polymer matrix can further comprise a hydrophilic polymer, an amine-containing polymer, or a combination thereof.

In certain embodiments, the polymer matrix can include a polyguanidine polymer and a hydrophilic polymer. In certain embodiments, the polymer matrix can include a polyguanidine polymer and an amine-containing polymer. In certain embodiments, the polymer matrix can include a polyguanidine polymer, a hydrophilic polymer, and an amine-containing polymer.

The polyguanidine polymer can serve as a “fixed carrier” or a “fixed-site carrier.” The polyguanidine polymer can have any suitable molecular weight. For example, the polyguanidine polymer can have a weight average molecular weight of from 5,000 Da to 5,000,000 Da, or from 50,000 Da to 2,000,000 Da.

Examples of polyguanidine polymers include, but are not limited to, polyethylene guanidine, polytrimethylene guanidine, polytetramethylene guanidine, polypentamethylene guanidine, polyhexamethylene guanidine, polyheptamethylene guanidine, polyoctamethylene guanidine, polyethylene N-methylguanidine, polytrimethylene N-methylguanidine, polytetramethylene N-methylguanidine, polypentamethylene N-methylguanidine, polyhexamethylene N-methylguanidine, polyheptamethylene N-methylguanidine, polyoctamethylene N-methylguanidine, polyethylene N,N′-dimethylguanidine, polytrimethylene N,N′-dimethylguanidine, polytetramethylene N,N′-dimethylguanidine, polypentamethylene N,N′-dimethylguanidine, polyhexamethylene N,N′-dimethylguanidine, polyheptamethylene N,N′-dimethylguanidine, polyoctamethylene N,N′-dimethylguanidine, poly(N-vinylguanidine), poly(N-allylguanidine), poly(N-butylguanidine), poly(N-pentylguanidine), poly(N-hexylguanidine), poly(N-heptylguanidine), poly(N-octylguanidine), copolymers thereof, and blends thereof.

Polyethylene guanidine (PEG) can be synthesized from the polycondensation of guanidine hydrochloride (GH) and ethylene diamine (EDA) as follows:

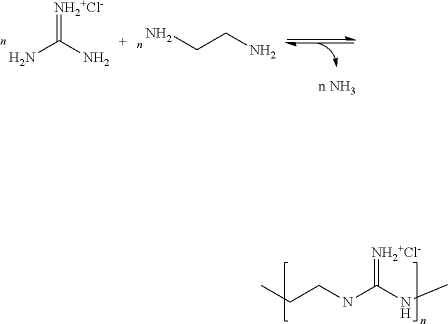

The leaving product, ammonia (NH₃), is removed from the polymer product.

Similarly, polytrimethylene guanidine and polytetramethylene guanidine can be synthesized from the polycondensation of guanidine hydrochloride with 1,3-propane diamine and 1,4-butane diamine, respectively, as shown in the following reactions, respectively:

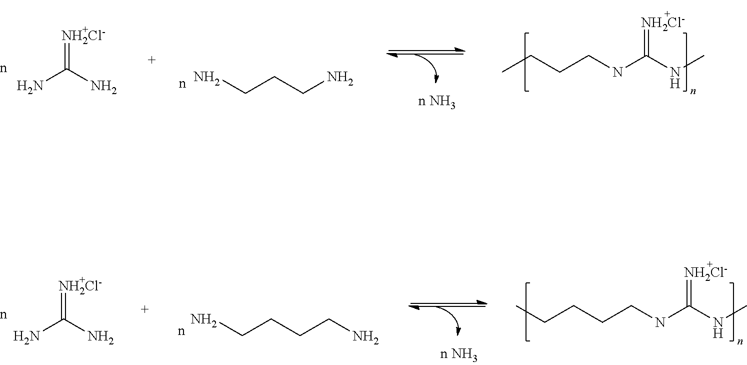

Polypentamethylene guanidine, polyhexamethylene guanidine, polyheptamethylene guanidine, and polyoctamethylene guanidine can also be synthesized from the polycondensation of guanidine hydrochloride with 1,5-pentane diamine, 1,6-hexane diamine, 1,7-heptane diamine, and 1,8-octane diamine, respectively. In a similar way, polyethylene N-methylguanidine, polytrimethylene N-methylguanidine, polytetramethylene N-methylguanidine, polypentamethylene N-methylguanidine, polyhexamethylene N-methylguanidine, polyheptamethylene N-methylguanidine, and polyoctamethylene N-methylguanidine can be prepared from the polycondensation of N-methylguanidine hydrochloride with ethylene diamine, 1,3-propane diamine, 1,4-butane diamine, 1,5-pentane diamine, 1,6-hexane diamine, 1,7-heptane diamine, and 1,8-octane diamine, respectively.

Similarly, polyethylene N,N′-dimethylguanidine, polytrimethylene N,N′-dimethylguanidine, polytetramethylene N,N′-dimethylguanidine, polypentamethylene N,N′-dimethylguanidine, polyhexamethylene,N,N′-dimethylguanidine, polyheptamethylene NN′-dimethylguanidine, and polyoctamethylene N,N′-dimethylguanidine can be prepared from the polycondensation of N,N′-dimethylguanidine hydrochloride with ethylene diamine, 1,3-propane diamine, 1,4-butane diamine, 1,5-pentane diamine, 1,6-hexane diamine, 1,7-heptane diamine, and 1,8-octane diamine, respectively.

The selective polymer layer can comprise any suitable amount of the polyguanidine polymer. For example, in some cases, the selective polymer layer can comprise from 10% to 90% by weight (e.g., from 10% to 70% by weight, from 10% to 50% by weight, from 20% to 50% by weight, or from 10% to 30% by weight) polyguanidine polymer, based on the total weight of the components used to form the selective polymer layer (the total dry weight of the selective polymer layer).

When present, the hydrophilic polymer can have any suitable molecular weight. For example, the hydrophilic polymer can have a weight average molecular weight of from 15,000 Da to 2,000,000 Da (e.g., from 50,000 Da to 200,000 Da). In some embodiments, the hydrophilic polymer can include polyvinylalcohol having a weight average molecular weight of from 50,000 Da to 150,000 Da. In other embodiments, the hydrophilic polymer can be a high molecular weight hydrophilic polymer. For example, the hydrophilic polymer can have a weight average molecular weight of at least 500,000 Da (e.g., at least 700,000 Da, or at least 1,000,000 Da).

The selective polymer layer can comprise any suitable amount of the hydrophilic polymer. For example, in some cases, the selective polymer layer can comprise from 10% to 90% by weight (e.g., from 10% to 50% by weight, or from 10% to 30% by weight) hydrophilic polymer, based on the total weight of the components used to form the selective polymer layer.

When present, the amine-containing polymer can include any suitable amine-containing polymer. Suitable examples of amine-containing polymers include, but are not limited to, polyvinylamine (PVAm), polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof. In some embodiments, the amine-containing polymer can comprise polyvinylamine (e.g., polyvinylamine having a weight average molecular weight of from 50,000 Da to 2,000,000 Da).

In some examples, the amine-containing polymer PVAm employed is purified from a commercial product named Polymin® VX from BASF (Vandalia, IL). The PVAm can have a high average molecular weight of 2,000 kDa. The amine-containing polymer can have a weight average molecular weight ranging from 300 to 3,000 kDa, but preferably to be higher than 1000 kDa.

The selective polymer layer can comprise any suitable amount of the amine-containing polymer. For example, in some cases, the selective polymer layer can comprise from 10% to 90% by weight (e.g., from 10% to 50% by weight, or from 10% to 30% by weight) amine-containing polymer, based on the total weight of the components used to form the selective polymer layer.

### Mobile Carriers

In some embodiments, the selective polymer layer can further comprise a mobile carrier dispersed within the polymer matrix. The mobile carrier can comprise any molecule that serves as a “mobile carrier” for CO₂ within the polymer matrix.

In some examples, the mobile carrier can comprise a guanidine-based mobile carrier, an amine-containing mobile carrier, or a combination thereof. In some embodiments, the mobile carrier can have a molecular weight of less than 1,000 Da (e.g., 800 Da or less, 500 or less, 300 Da or less, or 250 Da or less).

In some examples, the mobile carrier can be selected from 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, amidine with the structure R₁—(C═NH)—NR₂R₃ where each of R₁, R₂, and R₃ groups being H or R=CₙH₂ₙ₊₁ with n ranging from 1 to 10, guanidine with the structure R₁—N(R₂)—(C═NH)—N R₃R₄ where each of R₁, R₂, R₃, and R₄ groups being H or R=CₙH₂ₙ₊₁ with n ranging from 1 to 10, and combinations thereof.

### Guanidine-Based Mobile Carriers

The guanidine-based mobile carrier can comprise any suitable compound comprising a guanidine moiety and having a molecular weight of less than 1,000 Da (e.g., 800 Da or less, 500 or less, 300 Da or less, or 250 Da or less). In some embodiments, the guanidine-based mobile carrier can be a water-soluble compound. In some embodiments, the guanidine-containing mobile carrier can be non-volatile at the temperatures at which the membrane will be stored or used.

In some embodiments, the guanidine-based mobile carrier can be a compound defined by Formula I below

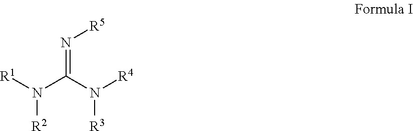

wherein
R¹ and R² are each independently selected from the group consisting of H, C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, wherein said C₁₋₆ alkyl, C₂₋₆ alkenyl, C₂₋₆ alkynyl, C₁₋₄ haloalkyl, C₃₋₁₀cycloalkyl, 6-10 membered aryl, 5-10 membered heteroaryl, and 4-10 membered heterocycloalkyl, are optionally substituted with 1, 2, 3, or 4 independently selected R^{A} groups, or R¹ and R², together with the N atom to which they are attached, form a 4-9 membered heterocycloalkyl group or a 5-6 membered heteroaryl group, each optionally substituted with 1, 2, or 3 independently selected R^{A} groups;
R³ and R⁴ are each independently selected from the group consisting of H, C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, wherein said C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, are optionally substituted with 1, 2, 3, or 4 independently selected R^{A} groups, or R³ and R⁴, together with the N atom to which they are attached, form a 4-9 membered heterocycloalkyl group or a 5-6 membered heteroaryl group, each optionally substituted with 1, 2, or 3 independently selected R^{A} groups;
R⁵ is selected from the group consisting of H, C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, wherein said C₁₋₆ alkyl, C₂₋₆ alkenyl, C₂₋₆ alkynyl, C₁₋₄ haloalkyl, C₃₋₁₀ to cycloalkyl, 6-10 membered aryl, 5-10 membered heteroaryl, and 4-10 membered heterocycloalkyl, are optionally substituted with 1, 2, 3, or 4 independently selected R^{A} groups; and
each R^{A} is independently selected from OH, NO₂, CN, halo, C₁₋₆ alkyl, C₂₋₆ alkenyl, C₂₋₆ alkynyl, C₁₋₄ haloalkyl, C₁₋₆ alkoxy, C₁₋₆ haloalkoxy, cyano-C₁₋₃ alkyl, HO—C₁₋₃ alkyl, amino, C₁₋₆ alkylamino, di(C₁₋₆ alkyl)amino, thio, C₁₋₆ alkylthio, C₁₋₆alkylsulfinyl, C₁₋₆ alkylsulfonyl, carbamyl, C₁₋₆alkylcarbamyl, di(C₁₋₆alkyl)carbamyl, carboxy, C₁₋₆ alkylcarbonyl, C₁₋₆ alkoxycarbonyl, C₁₋₆ alkylcarbonylamino, C₁₋₆ alkylsulfonylamino, aminosulfonyl, C₁₋₆ alkylaminosulfonyl, di(C₁₋₆ alkyl)aminosulfonyl, aminosulfonylamino, C₁₋₆ alkylaminosulfonylamino, di(C₁₋₆ alkyl)aminosulfonylamino, aminocarbonylamino, C₁₋₆ alkylaminocarbonylamino, and di(C₁₋₆alkyl)aminocarbonylamino.

In some embodiments, R¹, R², R³, and R⁴ are all C₁₋₄ alkyl (e.g., methyl).

In some embodiments, R⁵ is H. In other embodiments, R⁵ can be C₁₋₆ alkyl optionally substituted with 1, 2, 3, or 4 independently selected R^{A} groups. For example, R⁵ can be a C₁₋₆ alkyl group substituted with an OH group, or a C₁₋₆ alkyl group substituted with an amino group.

In some examples, the guanidine-based mobile carrier can comprise one of the following

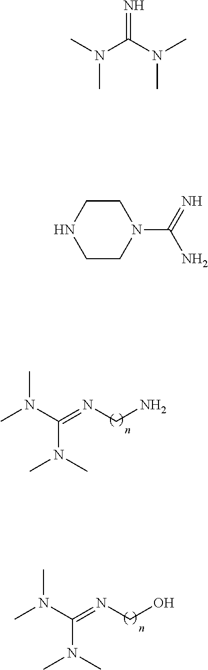

wherein n is an integer from 1 to 12, such as from 1 to 6. TMG is tetramethyguanidine, and PZC is piperazine-1-carboximidamide.

### Amine-Containing Mobile Carriers

Suitable amine-containing mobile carriers can include small molecules comprising one or more primary amine moieties and/or one or more secondary amine moieties, such as an amino acid salt.

In some embodiments, the amine-containing mobile carrier can have a molecular weight of 1,000 Da or less (e.g., 800 Da or less, 500 or less, 300 Da or less, or 250 Da or less). In some embodiments, the amine-containing mobile carrier can be non-volatile at the temperatures at which the membrane will be stored or used. For example, amine-containing mobile carrier can comprise a salt of a primary amine or a salt of a secondary amine.

In some cases, the amine-containing mobile carrier can include an aminoacid salt. The amino acid salt can be a salt of any suitable amino acid. The amino acid salt may be derived, for instance, from glycine, arginine, lysine, histidine, 6-aminohexanoic acid, proline, sarcosine, methionine, or taurine. In some cases, the amino acid salt can comprise a salt of a compound defined by the formula below

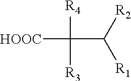

Wherein, independently for each occurrence in the amino acid, each of R₁, R₂, R₃ and R₄ is selected from one of the following

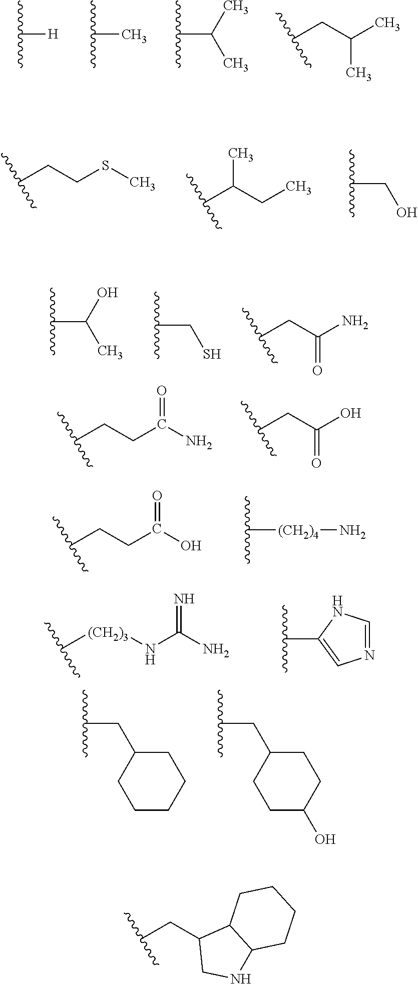

or R₁ and R₃, together with the atoms to which they are attached, form a five-membered heterocycle defined by the structure below when n is 1, or a six-membered heterocycle defined by the structure below when n is 2

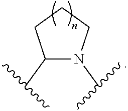

Poly(amino-acids), for example, polyarginine, polylysine, polyonithine, or polyhistidine may also be used to prepare the amino acid salt.

In other embodiments, the amine-containing mobile carrier can be defined by a formula below

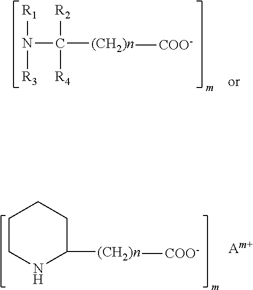

wherein R₁, R₂, R₃, and R₄ are hydrogen or hydrocarbon groups having from 1 to 4 carbon atoms, n is an integer ranging from 0 to 4, A^{m+} is a cation having a valence of 1 to 3. In some cases, the cation (A^{m+}) can be an amine cation having the formula:

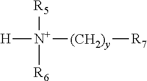

wherein R₅ and R₆ are hydrogen or hydrocarbon groups having from 1 to 4 carbon atoms, R₇ is hydrogen or hydrocarbon groups having from 1 to 4 carbon atoms or an alkyl amine of from 2 to 6 carbon atoms and 1 to 4 nitrogen atoms, y is an integer ranging from 1 to 4, and in is an integer equal to the valence of the cation. In some embodiments, A^{m+} is a metal cation selected from Groups Ia, IIa, and IIIa of the Periodic Table of Elements or a transition metal. For example, A^{m+} can comprise lithium, aluminum, or iron.

Other suitable amine-containing mobile carriers include aminoisobutyric acid-potassium salt, aminoisobutyric acid-lithium salt, aminoisobutyric acid-piperazine salt, glycine-potassium salt, glycine-lithium salt, glycine-piperazine salt, dimethylglycine-potassium salt, dimethylglycine-lithium salt, dimethylglycine-piperazine salt, piperadine-2-carboxlic acid-potassium salt, piperadine-2-carboxlic acid-lithium salt, piperadine-2-carboxlic acid-piperazine salt, piperadine-4-carboxlic acid-potassium salt, piperadine-4-carboxlic acid-lithium salt, piperadine-4-carboxlic acid-piperazine salt, piperadine-3-carboxlic acid-potassium salt, piperadine-3-carboxlic acid-lithium salt, piperadine-3-carboxlic acid-piperazine salt, and blends thereof.

### CO₂-Philic Ethers

Optionally, the selective polymeric layer can further include a one or more CO₂-philic ethers dispersed within the polymer matrix. The CO₂-philic ether can be a polymer, oligomer, or small molecule containing one or more ether linkages. Examples of CO₂-philic ethers include alcohol ethers, polyalkylene alcohol ethers, polyalkylene glycols, poly(oxyalkylene)glycols, poly(oxyalkylene)glycol ethers, and ethoxylated phenol. In one embodiment, the CO₂-philic ether can comprise alkyl ethoxylate (C₁-C₆)-(EO)x, where x=1-30 and the ethoxylate is linear or branched. In some embodiments, the CO₂-philic ether can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), or any combination thereof.

### Graphene Oxide

Optionally, the selective polymer layer can further include graphene oxide dispersed within the polymer matrix.

The term “graphene” refers to a one-atom-thick planar sheet of sp²-bonded carbon atoms that are densely packed in a honeycomb crystal lattice. In one embodiment, it refers to a single-layer version of graphite.

The term “graphene oxide” herein refers to functionalized graphene sheets (FGS)—the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g., approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “m”, where m ranges from 3 to about 20, inclusive. For example, graphene oxide having a C:O ratio of between 3 and 20 is referred to as “GO(3) to GO(20)”, where m ranges from 3 to 20, e.g., m=3, 4, 5, 6, 7, 8, 9, 10, 11, 12, 13, 14, 15, 16, 17, 18, 19 or 20, including all decimal fractions of 0.1 increments in between, e.g., a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g., about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g., “GO(2)” refers to graphene oxide with a C:O ratio of 2.

In some embodiments, the graphene oxide can be GO(m). In some embodiments, the graphene oxide can be GO(L). In some embodiments, the graphene oxide can be nanoporous.

### Other Components

In some embodiments, the polymer matrix can further include a cross-linking agent. Cross-linking agents suitable for use in the polymer matrix can include, but are not limited to, formaldehyde, glutaraldehyde, maleic anhydride, glyoxal, divinylsulfone, toluenediisocyanate, trimethylol melamine, terephthalatealdehyde, epichlorohydrin, vinyl acrylate, and combinations thereof. In some embodiments, the cross-linking agent can comprise formaldehyde, glutaraldehyde, or maleic anhydride. The polymer matrix can comprise any suitable amount of the cross-linking agent. For example, the polymer matrix can comprise 1 to 40 percent cross-linking agents by weight of the polymer matrix.

The polymer matrix can further include a base. The base can act as a catalyst to catalyze the cross-linking of the polymer matrix (e.g, cross-linking of a hydrophilic polymer with an amine-containing polymer). In some embodiments, the base can remain in the polymer matrix and constitute a part of the polymer matrix. Examples of suitable bases include potassium hydroxide, sodium hydroxide, lithium hydroxide, triethylamine, N,N-dimethylaminopyridine, hexamethyltriethylenetetraamine, potassium carbonate, sodium carbonate, lithium carbonate, and combinations thereof. In some embodiments, the base can include potassium hydroxide. The polymer matrix can comprise any suitable amount of the base. For example, the polymer matrix can comprise 1 to 40 percent base by weight of the polymer matrix.

The selective polymer layer further comprises carbon nanotubes dispersed within the polymer matrix. Any suitable carbon nanotubes (prepared by any suitable method or obtained from a commercial source) can be used. The carbon nanotubes can comprise single-walled carbon nanotubes, multiwalled carbon nanotubes, or a combination thereof.

In some cases, the carbon nanotubes can have an average diameter of at least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above. For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then couple to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the selective polymer layer can comprise at least 0.5% (e.g., at least 1%, at least 1.5%, at least 2%, at least 2.5%, at least 3%, at least 3.5%, at least 4%, or at least 4.5%) by weight carbon nanotubes, based on the total dry weight of the selective polymer layer. In some embodiments, the selective polymer layer can comprise 5% or less (e.g., 4.5% or less, 4% or less, 3.5% or less, 3% or less, 2.5% or less, 2% or less, 1.5% or less, or 1% or less) by weight carbon nanotubes, based on the total dry weight of the selective polymer layer.

The selective polymer layer can comprise an amount of carbon nanotubes ranging from any of the minimum values described above to any of the maximum values described above. For example, the selective polymer layer can comprise from 0.5% to 5% (e.g., from 1% to 3%) by weight carbon nanotubes, based on the total dry weight of the selective polymer layer.

If desired, the selective polymer layer can be surface modified by, for example, chemical grafting, blending, or coating to improve the performance of the selective polymer layer. For example, hydrophobic components may be added to the selective polymer layer to alter the properties of the selective polymer layer in a manner that facilitates greater fluid selectivity.

The total thickness of each layer in the membrane can be chosen such that the structure is mechanically robust, but not so thick as to impair permeability. In some embodiments, the selective polymer layer can have a thickness of from 50 nanometers to 5 microns (e.g., from 50 nm to 2 microns, or from 100 nanometers to 750 nanometers, or from 250 nanometers to 500 nanometers). In some embodiments, the support layer can have a thickness of from 1 micron to 500 microns (e.g., from 50 to 250 microns). In some cases, the membranes disclosed herein can have a thickness of from 5 microns to 500 microns.

### Methods of Making

Methods of making these membranes are also disclosed herein. Methods of making membranes can include depositing (e.g., coating) a selective polymer layer on a support layer to form a selective layer disposed (e.g., coated) on the support layer.

Optionally, the support layer can be pretreated prior to deposition (e.g., coating) of the selective polymer layer, for example, to remove water or other adsorbed species using methods appropriate to the support and the adsorbate. Examples of absorbed species are, for example, water, alcohols, porogens, and surfactant templates.

The selective polymer layer can be prepared by first forming a coating solution including the components of the polymer matrix (e.g., a polyguanidine polymer and one or more additional components, such as a hydrophilic polymer, an amine-containing polymer, a mobile carrier such as a guanidine-based mobile carrier or an amine-based mobile carrier, a CO₂-philic ether, graphene oxide, carbon nanotubes, a cross-linking agent, a basic compound, or a combination thereof) in a suitable solvent. One example of a suitable solvent is water. In some embodiments, the amount of water employed will be in the range of from 50% to 99%, by weight of the coating solution. The coating solution can then be used in forming the selective polymer layer. For example, the coating solution can be coated onto a support later (e.g., a nanoporous gas permeable membrane) using any suitable technique, and the solvent may be evaporated such that a nonporous membrane is formed on the substrate. Examples of suitable coating techniques include, but are not limited to, “knife coating” or “dip coating”. Knife coating includes a process in which a knife is used to draw a polymer solution across a flat substrate to form a thin film of a polymer solution of uniform thickness after which the solvent of the polymer solution is evaporated, at ambient temperatures or temperatures up to about 100 °C or higher, to yield a fabricated membrane. Dip coating includes a process in which a polymer solution is contacted with a porous support. Excess solution is permitted to drain from the support, and the solvent of the polymer solution is evaporated at ambient or elevated temperatures. The membranes disclosed can be shaped in the form of hollow fibers, tubes, films, sheets, etc. In certain embodiments, the membrane can be configured in a flat sheet, a spiral-wound, a hollow fiber, or a plate-and-frame configuration.

In some embodiments, membranes can be heated at a temperature and for a time sufficient for cross-linking to occur. In one example, cross-linking temperatures in the range from 80 °C to 100 °C can be employed. In another example, cross-linking can occur from 1 to 72 hours. The resulting solution can be coated onto the support layer and the solvent evaporated, as discussed above. In some embodiments, a higher degree of cross-linking for the polymer matrix after solvent removal takes place at about 100 °C to about 180 °C, and the cross-linking occurs in from about 1 to about 72 hours.

An additive may be included in the selective polymer layer before forming the selective polymer layer to increase the water retention ability of the membrane. Suitable additives include, but are not limited to, polystyrenesulfonic acid-potassium salt, polystyrenesulfonic acid-sodium salt, polystyrenesulfonic acid-lithium salt, sulfonated polyphenyleneoxides, alum, and combinations thereof. In one example, the additive comprises polystyrenesulfonic acid-potassium salt.

In some embodiments, the method of making these membranes can be scaled to industrial levels.

### Methods of Use

The membranes disclosed herein can be used for separating gaseous mixtures. For example, provided are methods for separating a first gas from a feed gas comprising the first gas and one or more additional gases (e.g., at least a second gas). The method can include contacting any of the disclosed membranes (e.g., on the side comprising the selective polymer) with the feed gas under conditions effective to afford transmembrane permeation of the first gas. In some embodiments, the method can also include withdrawing from the reverse side of the membrane a permeate containing at least the first gas, wherein the first gas is selectively removed from the gaseous stream. The permeate can comprise at least the first gas in an increased concentration relative to the feed stream. The term “permeate” refers to a portion of the feed stream which is withdrawn at the reverse or second side of the membrane, exclusive of other fluids such as a sweep gas or liquid which may be present at the second side of the membrane.

The membrane can be used to separate gases at any suitable temperature, including temperatures of 57 °C or greater. For example, the membrane can be used at temperatures of from 57 °C to 97 °C. In some embodiments, a vacuum can be applied to the permeate face of the membrane to remove the first gas. In some embodiments, a sweep gas can be flowed across the permeate face of the membrane to remove the first gas. Any suitable sweep gas can be used. Examples of suitable sweep gases include, for example, air, steam, nitrogen, argon, helium, and combinations thereof.

The first gas can include an acid gas. For example, the first gas can be carbon dioxide, hydrogen sulfide, sulfur dioxide, sulfur trioxide, nitrogen oxide, or combinations thereof. In some embodiments, the membrane can be selective to carbon dioxide versus hydrogen, nitrogen, carbon monoxide, or combinations thereof. In some embodiments, the membrane can be selective to hydrogen sulfide versus hydrogen, nitrogen, carbon monoxide, or combinations thereof.

In certain embodiments, the first gas can comprise carbon dioxide and the second gas can comprise hydrogen. In certain embodiments, the first gas can comprise carbon dioxide and the second gas can comprise nitrogen.

The permeance of the first gas or the acid gas can be at least 50 GPU (e.g., 75 GPU or greater, 100 GPU or greater, 150 GPU or greater, 200 GPU or greater, 250 GPU or greater, 300 GPU or greater, 350 GPU or greater, 400 GPU or greater, 450 GPU or greater, 500 GPU or greater, 550 GPU or greater, 600 GPU or greater, 650 GPU or greater, 700 GPU or greater, 750 GPU or greater, 800 GPU or greater, 850 GPU or greater, 900 GPU or greater, 950 GPU or greater, 1000 GPU or greater, 1100 GPU or greater, 1200 GPU or greater, 1300 GPU or greater, 1400 GPU or greater, 1500 GPU or greater, 1600 GPU or greater, 1700 GPU or greater, 1800 GPU or greater, 1900 GPU or greater, 2000 GPU or greater, 2100 GPU or greater, 2200 GPU or greater, 2300 GPU or greater, or 2400 GPU or greater) at 57 °C and 4 bar feed pressure.

The permeance of the first gas or the acid gas can be 2500 GPU or less at 57 °C and 4 bar feed pressure (e.g., 2400 GPU or less, 2300 GPU or less, 2200 GPU or less, 2100 GPU or less, 2000 GPU or less, 1900 GPU or less, 1800 GPU or less, 1700 GPU or less, 1600 GPU or less, 1500 GPU or less, 1400 GPU or less, 1300 GPU or less, 1200 GPU or less, 1100 GPU or less, 1000 GPU or less, 950 GPU or less, 900 GPU or less, 850 GPU or less, 800 GPU or less, 750 GPU or less, 700 GPU or less, 650 GPU or less, 600 GPU or less, 550 GPU or less, 500 GPU or less, 450 GPU or less, 400 GPU or less, 350 GPU or less, 300 GPU or less, 250 GPU or less, 200 GPU or less, 150 GPU or less, 100 GPU or less, or 75 GPU or less).

The permeance of the first gas or the acid gas through the membrane can vary from any of the minimum values described above to any of the maximum values described above or even higher. For example, the permeance of the first gas or the acid gas can be from 50 GPU to 1500 GPU or even to 3000 GPU at 57 °C and 4 bar feed pressure (e.g., from 300 GPU to 1500 GPU at 57 °C, or from 500 GPU to 1500 GPU or even to 3000 GPU at 57 °C and 4 bar feed pressure).

The membrane can exhibit a first gas/second gas selectivity of at least 10 at 57 °C and 4 bar feed pressure. In some embodiments, the membrane can exhibit a first gas/second gas selectivity of up to 500 at 57 °C and 4 bar feed pressure. For example, the membrane can exhibit a first gas/second gas selectivity of 10 or greater, 25 or greater, 50 or greater, 75 or greater, 100 or greater, 125 or greater, 150 or greater, 175 or greater, 200 or greater, 225 or greater, 250 or greater, 275 or greater, 300 or greater, 325 or greater, 350 or greater, 375 or greater, 400 or greater, 425 or greater, 450 or greater, or 475 or greater at 57 °C and 4 bar feed pressure. In some embodiments, the permeance and selectivity of the membrane for the first gas or the acid gas can vary at higher or lower temperatures.

By way of non-limiting illustration, examples of certain embodiments of the present disclosure are given below.

### EXAMPLES

### Overview

These Examples describes polyguanidine-containing membranes for the separation of CO₂ from gaseous streams. The polymeric selective layer, coated on top of a highly permeable nanoporous polymer support, can, for example, comprise polyguanidine as the fixed-site carrier or a mixture of polyguanidine and an amine-containing polymer as fixed-site carriers. The fixed-site carrier or fixed-site carriers may serve as the polymer matrix to contain CO₂-reactive small molecules as mobile carriers in the membrane, which further facilitate the CO₂ transport across the membrane. An example of the amine-containing polymer is polyvinylamine. Moreover, perforated graphene oxide mono-sheets were dispersed in the selective layer to reinforce the flexural rigidity of the selective layer in the membrane upon feed compression and vacuum suction. An example membrane synthesized in this way showed excellent CO₂/N₂ separation performance. An 8″-diameter spiral-wound (SW) membrane module containing 35 m² membrane was fabricated and tested against simulated and actual coal flue gases, demonstrating stable membrane performance in the presence of O₂, SO₂, and NO₂. In addition, an integrated bench skid with two SW membrane modules forming an enriching cascade was also constructed, which successfully removed 91% of the CO₂ in a simulated coal flue gas and enriched it to >95% purity. Furthermore, the polymer matrix optionally contains a hydrophilic polymer, e.g., polyvinylalcohol.

### Background

CO₂ emissions in the world declined by 5.8% in 2020, or almost 2 giga tonne (Gt) carbon dioxide, which was the largest ever decline due to the COVID-19 pandemic. Despite this decline, energy-related CO₂ emissions remained high at 31.5 Gt, and this contributed to CO₂ reaching its highest ever average annual concentration in the atmosphere of 412.5 ppm in 2020. In 2016, the combustion of coal still accounts for 50% electricity supply and about a third of CO₂ emissions in the U.S. Carbon capture and storage could play an important role in cutting the carbon footprint in the energy sector.

Retrofitting a current coal-fired power plant by an amine solution-based capture system would increase the cost of electricity by 70-80% and incur a 25-40% energy penalty. However, membranes, as one of the promising next-generation energy-efficient technologies, have demonstrated many industrial applications such as hydrogen recovery, air separation, and natural gas sweetening. A widely engaged approach for polymeric membrane synthesis is to coat a thin selective layer of polymer onto a nanoporous polymer support, i.e., typically ultrafiltration membranes made from polysulfone, polyethersulfone, or polyetherimide. Multiple research efforts have been dedicated in designing polymers with high CO₂ permeance and decent CO₂/N₂ selectivity. On one hand, polar functional groups, such as ethylene oxide group, have been incorporated to increase the physical CO₂ solubility in the polymer matrix, and the dissolved CO₂ molecules diffuse through the membrane. On the other hand, reactive functional groups and compounds have been used as carriers to reversibly react with CO₂. The chemical reaction enhances the permeation of CO₂ through the membrane, and this type of membrane is named as facilitated transport membrane.

For facilitated transport membranes, amines are the most exploited CO₂ carriers. The reaction mechanisms between CO₂ and amines are depicted in Scheme I. The reactivity of CO₂ derives from the high electron deficiency of the carbon bonded to the two highly electronegative oxygens. For primary and secondary amines with a lone electron pair on the nitrogen atom, the amine functions as a nucleophile, i.e., a Lewis base, which attacks the electrophile carbonyl group on CO₂ to form a zwitterion. The zwitterion rapidly equilibrates to the corresponding carbamic acid and then is deprotonated by another amine to form a more stable carbamate ion, which leads to 2 moles of amine for 1 mole of CO₂. Many successes have been reported by exploring various amine structures, yielding highly CO₂-selective membranes with considerable CO₂ permeance.

CO₂+RNH₂⇄RNH₂⁺COO⁻⇄RHNCOOH

RHNCOOH+RNH₂←RHNCOO⁻+RNH₃⁺

### Scheme I. Reaction Between Amine and CO₂: Zwitterion Mechanism.

Although the amine structure can be further fine-tuned to enhance the CO₂ loading capacity such as using sterically hindered polyvinylamine membranes, there are other CO₂-reactive carriers that are worthwhile exploring. One promising candidate is a class of strong organic base, guanidine. The guanidine group has a high electron density due to the efficient resonance stabilization of the charges on its three amino groups connected to the carbon center. This feature can be capitalized for efficient CO₂ fixation as shown in Scheme II:

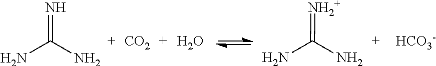

Scheme II. Reactions Among Guanidine, CO₂, and H₂O Via the Bicarbonate Mechanism.

Guanidine can attack the electron deficient carbon center of CO₂ as a nucleophile to form a zwitterion. However, the zwitterion is unstable and then further hydrolyzed to bicarbonate in the presence of water, presumably due to the steric hindrance from the other two amino groups. The bicarbonate reaction mechanism leads to 1 mole of CO₂ for 1 mole of guanidine, which is very effective for CO₂ sorption in a membrane containing the guanidine.

In these Examples, the preparation of polymeric membranes including polyguanidines for separation of CO₂ from gaseous streams are described. The polymeric selective layer, coated on top of a highly permeable nanoporous polymer support, can comprise polyguanidine as the fixed-site carrier or a mixture of polyguanidine and an amine-containing polymer as fixed-site carriers. The fixed-site carrier or fixed-site carriers may serve as the polymer matrix to contain CO₂-reactive small molecules as mobile carriers in the membrane. Both the fixed-site and mobile carriers (when present) facilitate the transport of CO₂ across the membrane. Moreover, perforated graphene oxide mono-sheets were dispersed in the selective layer to reinforce the flexural rigidity of the selective layer in the membrane upon feed compression and vacuum suction. Furthermore, the polymer matrix optionally includes a hydrophilic polymer, e.g., polyvinylalcohol. The membranes can exhibit excellent CO₂/N₂ separation performance.

### Materials and Methods

Materials. 2-(1-piperazinyl)ethylamine (PZEA, 99%), sarcosine (Sar, 98%), piperazine-1-carboximidamide, ethylenediamine (EDA, >=99%), and deuterium oxide (D₂O, 99.9 atom % D) were purchased from Sigma-Aldrich (Milwaukee, WI). Piperazine-1-carboximidamide (PZC, 99%) was bought from VWR (Radnor, PA). Guanidine hydrochloride (GH, 99+%) and monolayer graphene oxide (GO) in the form of solid flakes were acquired from TCI America (Portland, OR). Strong base anion exchange resin (Purolite® A6000H) was donated by Purolite Corp. (Bala Cynwyd, PA). All the chemicals, except GO that will be described later, were used as received without further purification. For gas permeation measurements, pre-purified CO₂ and argon were purchased from Praxair Inc. (Danbury, CT).

Preparation of Nanoporous Graphene Oxide (GO). The GO was dispersed in water (~1 mg/ml) by an ultrasonication probe with a power of 2500 W for 3 hr. KOH solution (50 wt. %) was added slowly into the GO dispersion with a KOH-to-GO weight ratio of 14.1 to prevent the precipitation of GO. The mixture was further ultrasonicated for 30 min. After this, the water was evaporated in a convection oven at 60 °C, followed by further drying in a vacuum oven at 60 °C overnight. The resultant solid was annealed at 200 °C for 2 h to create pores on the GO basal plane. After the thermal treatment, the solid was washed by DI water under vacuum filtration until the filtrate reached a pH of 7. The purified nanoporous GO (nGO) was dispersed in water again (~1 mg/ml) using an ultrasonication bath.

Coating Solution and Membrane Preparation. The nGO-reinforced composite membranes were synthesized by using the following procedures.

First, the purified PVAm solution was concentrated to 4 wt. % by evaporating water under nitrogen purge at 50 °C. The nGO dispersion with a concentration of ~1 mg/ml was added dropwise to the polymer solution by a 10-μL glass capillary tube under vigorous agitation, aiming for 1.5 wt. % nGO loading in the final total solid of the coating solution. The mixture was transferred to a 15-mL conical centrifuge tube, in which it was homogenized by the ⅛″ Microtip sonication probe with a 50% amplitude until uniformly dispersed. The sonication was carried out in an ice bath. The water introduced by the nGO dispersion was vaporized by a nitrogen purge.

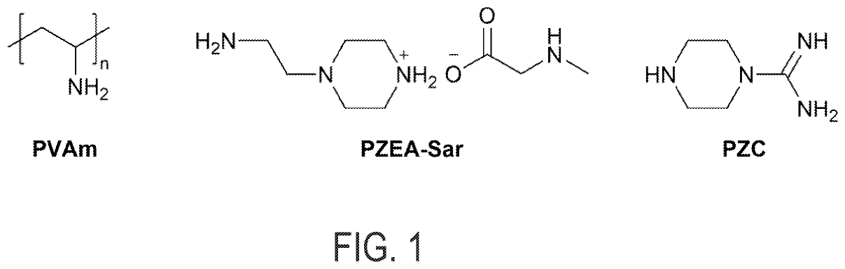

The aminoacid salt mobile carriers were synthesized by reacting the base, PZEA, with the aminoacid, Sar. The stoichiometric amount of Sar was added in a 24 wt. % PZEA aqueous solution under vigorous mixing. The solution was mixed at room temperature for 2 h before use. The chemical structures of PVAm, PZEA-Sar, and PZC are shown in FIG. 1.

The certain amounts of the mobile carrier solutions, including the aminoacid salt and/or PZC, were incorporated in the dispersion to form the coating solution. After centrifugation at 8,000×g for 3 min to remove any air bubbles and/or particulates, the coating solution was coated on a nanoporous polyethersulfone (PES) substrate by a GARDCO adjustable micrometer film applicator (Paul N. Gardner Company, Pompano Beach, FL) with a controlled gap setting. The PES substrate was synthesized in house with a surface average pore size of 35 nm. Ideally, the coating solution should have a viscosity>1100 cp at a total solid content<15 wt. % in order to form a defect-free selective layer with a thickness of ca. 170 nm. The membrane was dried in a fume hood at room temperature for at least 6 h before testing.

Gas Permeation Measurements. The transport properties of the composite membrane were measured by using a gas permeation apparatus. The synthesized membrane was loaded into a stainless-steel rectangular permeation cell with an effective area of 2.7 cm² inside a temperature-controlled oven (Bemco Inc. Simi Valley, CA). The membrane was supported by a sintered stainless-steel plate with an average pore size of 100 μm. A 100-sccm dry feed gas containing 20% CO₂ and 80% N₂ was used. The mixed gas was achieved by mixing the two gas streams of CO₂ and N₂ controlled by two mass flow controllers, respectively. The feed gas was fully saturated with water vapor by bubbling through 100 mL water in a 500-mL stainless-steel humidifier (Swagelok, Westerville, OH) packed with 60 vol. % Raschig rings. The humidifier temperature was controlled at 57 °C, which is the typical flue gas temperature leaving the flue gas desulfurization (FGD) unit. However, a higher temperature, e.g., 77 °C, may also be used. The feed pressure was controlled at 1-5 atm (abs) by a near-ambient pressure regulator. The outlet gas was sent to an Agilent 6890N gas chromatography (GC, Agilent Technologies, Palo Alto, CA) for composition analysis after the moisture was knocked out by a condenser at room temperature. The GC was equipped with thermal conductivity detectors and a SUPELCO Carboxen® 1004 micropacked GC column (Sigma-Aldrich, St. Louis, MO).

The permeate side of the permeation cell was connected to an Ebara MD1 vacuum diaphragm pump (Ebara Technologies, Inc., Sacramento, CA). The permeate pressure was controlled precisely at 0.1-0.9 atm by a vacuum regulator (VC, Alicat Scientific, Inc., Tucson, AZ). Before the permeate stream entered the vacuum pump, it passed through a 1-L stainless-steel water knockout vessel that was cooled by a chiller (Fisher Scientific, Hampton, NH) at 0 °C to remove the moisture. A 30-sccm dry argon was used to carry the vacuum pump discharge to the GC for composition analysis.

### Example 1. Synthesis of Polyethylene Guanidine from Guanidine Hydrochloride and Ethylenediamine

Polyethylene guanidine (PEG) was synthesized by the polycondensation of guanidine hydrochloride (GH) and EDA under a dry nitrogen atmosphere. Before the synthesis, a 50 mL three-neck round-bottom reaction flask connected to a distillation apparatus was dried by heating via immersion in an oil bath at 100 °C for an hour. After cooling to room temperature, 55 mmol EDA and 50 mmol GH were consecutively added into the reaction flask and stirred for 10 min. In order to initiate the reaction, the oil bath temperature was raised to 120 °C at 1 atm in 35 min. Subsequently, the stirring strength was increased from the medium to the maximum level in 20 min. After cooling, the polycondensation process was continued by reducing the reaction pressure to 10 torr. Under the vacuum, the oil bath temperature was slowly raised to 220 °C in 60 min. After being maintained at 220 °C for 10 min, the oil bath temperature was raised to 240 °C in 10 min and maintained at 240 °C for another 10 min to finish the polymerization. Finally, the reaction system was cooled to room temperature, and the vacuum was released before the polymer product was collected. The yield of PEG, calculated based on the amount of GH, was 85.47%. The PEG product was ion-exchanged by using Purolite® A6000H anion-exchange resin to remove the hydrochloride before further use.

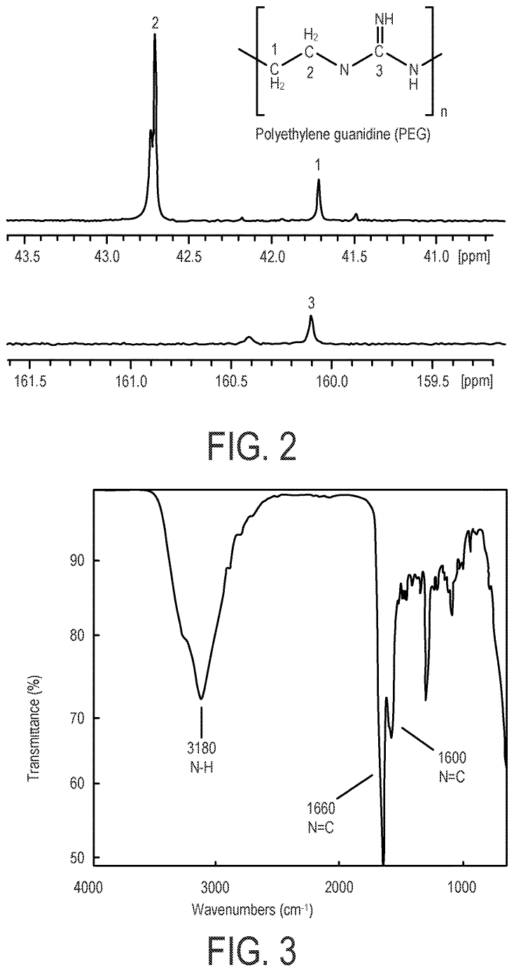

The 400 MHz ¹³C nuclear magnetic resonance (NMR) spectrum of the purified PEG is shown in FIG. 2. Due to the resonance stabilization of the guanidine groups (coded as 3, at ~160.1 ppm), the methylene groups coded as 1 and 2 appeared at ~41.7 ppm and ~42.7 ppm, respectively, according to how close they were relative to the guanidine group.

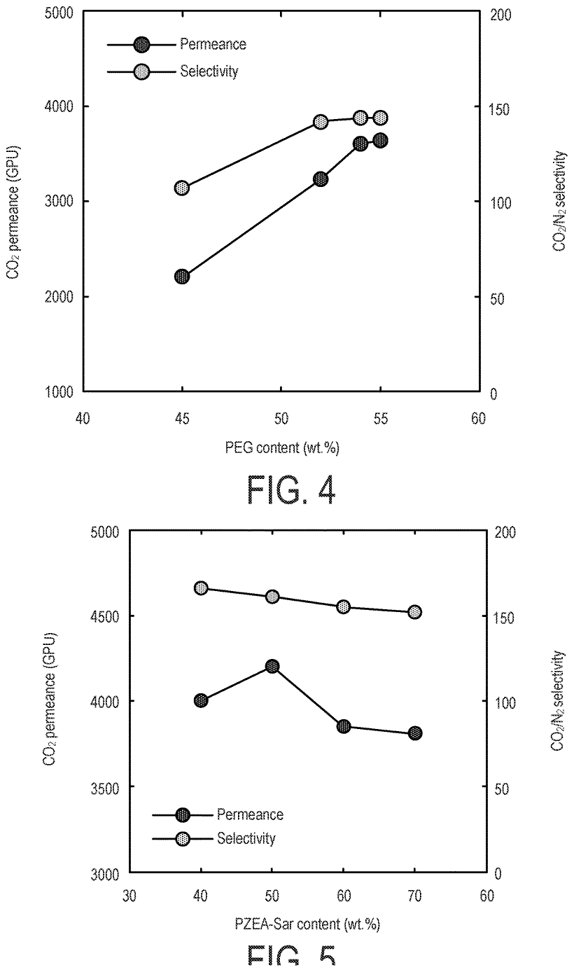

The purified PEG was also characterized by Fourier transform infrared (FTIR) spectroscopy using a Nicolet 470 FTIR spectrometer (Thermo Electron Co., Waltham, MA) to confirm the characteristic bands of ethyl guanidine as presented in FIG. 3. The characteristic —N═C— peaks of the guanidine group appeared at around 1600 and 1660 cm⁻¹. The absorption band due to the N—H stretching vibration of the guanidine group was also observed at around 3180 cm⁻¹. The absorption band of the C—H stretching vibration at around 2900 cm⁻¹ was not clearly identified and might be overlapped with that of the N—H stretching vibration.

Static light scattering (SLS) experiments were conducted on the PEG product, which indicated a molecular weight of 2.09 MDa.

### Example 2. Membranes Comprising 20 wt. % PZEA-Sar, 20 wt. % PZC, and Various Contents of PEG with Balance of PVAm

The mobile carriers, including PZEA-Sar and PZC, were incorporated into the PEG in this example. All membranes contained 40 wt. % mobile carriers with the 1:1 weight ratio of PZEA-Sar and PZC. Various contents of PVAm and PEG were incorporated in the membrane as fixed-site carriers as well as the polymer matrix to host the mobile carriers.

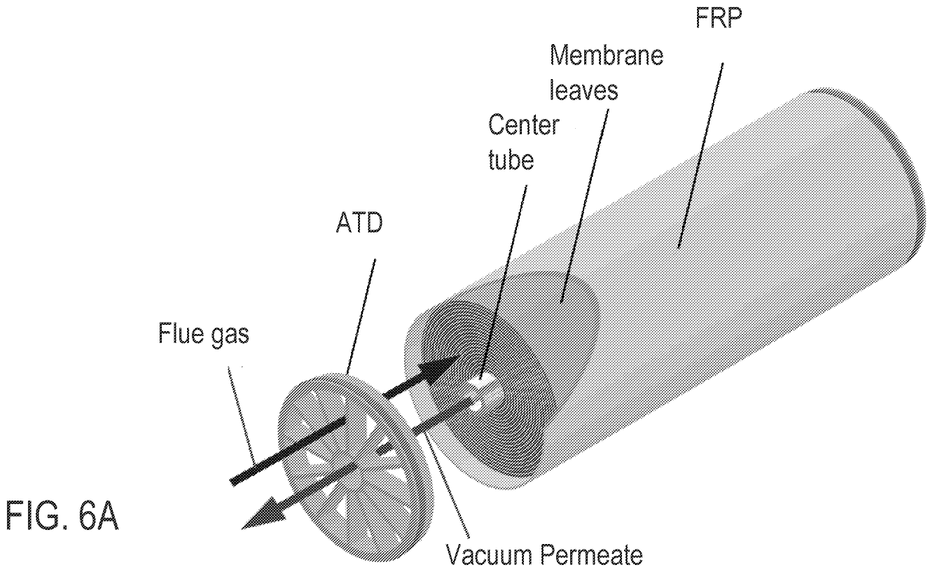

The aforementioned membranes were tested at 77 °C with a feed pressure of 4 atm and a vacuum pressure of 0.4 atm. The transport results are shown in FIG. 4. As seen, the CO₂ permeance increased from 2211 to 3643 GPU with increasing PEG content from 45 to 55 wt. %. Correspondingly, the CO₂/N₂ selectivity increased from 107 to 144. The improved CO₂/N₂ separation performance was attributed to the higher content of guanidine groups in the membrane, which were more effective to facilitate the CO₂ transport than the primary amino groups in PVAm.

### Example 3. Membranes Comprising 6 wt. % PVAm, 40-70 wt. % PZEA-Sar, and Balance of PEG

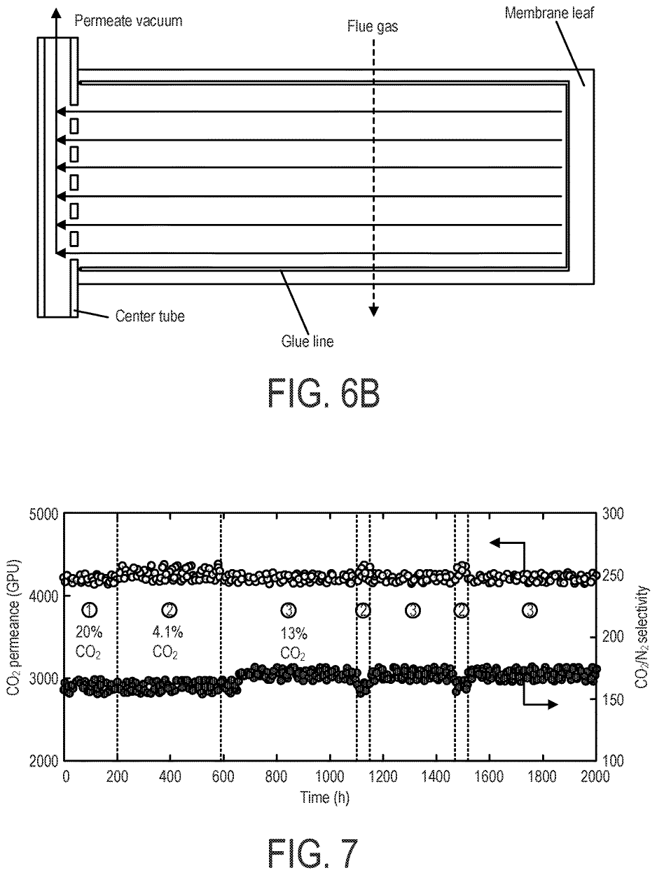

This Example shows the effect of the incorporation of the aminoacid salt mobile carrier, PZEA-Sar, in the membrane on membrane separation performance. This was demonstrated by a series of membranes containing 6 wt. % PVAm, 40-70 wt. % PZEA-Sar, and balance of PEG, in which PZC was not included in the membranes. As shown in FIG. 5, the CO₂ permeance increased from 4005 to 4203 GPU when the PZEA-Sar content was increased from 40 to 50 wt. %. Further increase in PZEA-Sar led to reduced CO₂ permeances. At 70 wt. % PZEA-Sar, the membrane only exhibited a CO₂ permeance of 3811 GPU, which was attributed to the reduced guanidine content as well as the weakened membrane matrix due to the lack of polymeric moieties. In comparison, the CO₂/N₂ selectivity was less sensitive to the PZEA-Sar content; all membranes showed CO₂/N₂ selectivities in the range of 150-170. Overall, the optimized membrane (6 wt. % PVAm, 44 wt. % PEG, and 50 wt. % PZEA-Sar) exhibited the highest CO₂ permeance of 4203 GPU with a CO₂/N₂ selectivity of 161. This membrane was adopted as the benchmark for the following examples.

### Example 4. Testing of Commercial-Size 8-Inch Diameter Prototype SW Module with Polyguanidine-Containing Membrane Using Simulated Flue Gases

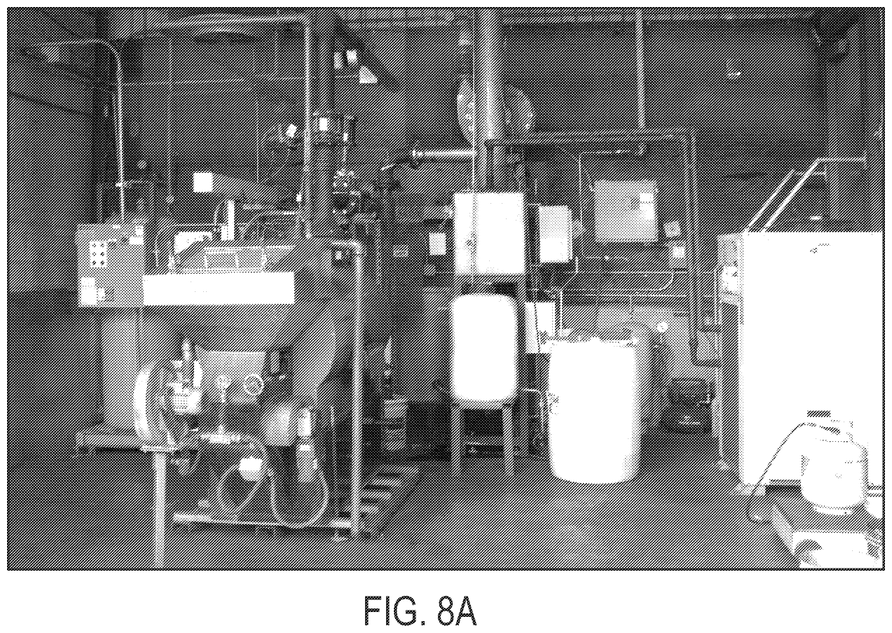

A spiral-wound (SW) module with the scale-up membrane containing PEG as the fixed-site carrier along with a mobile carrier was fabricated. The membrane composition was detailed in Example 3 as the benchmark membrane. The module had the commercial-size diameter of 8 inches with a length of 22 inches. The SW membrane element contained 41 membrane leaves, each with a width of 20 inches and a length of 36 inches, yielding a total membrane area of 35 m². As shown in FIGS. 6A-6B, the feed gas was introduced on the one end of the SW element with the retentate coming out on the other. A vacuum was applied on the permeate side to withdraw the permeated gas to the center tube, resulting in a crossflow pattern.

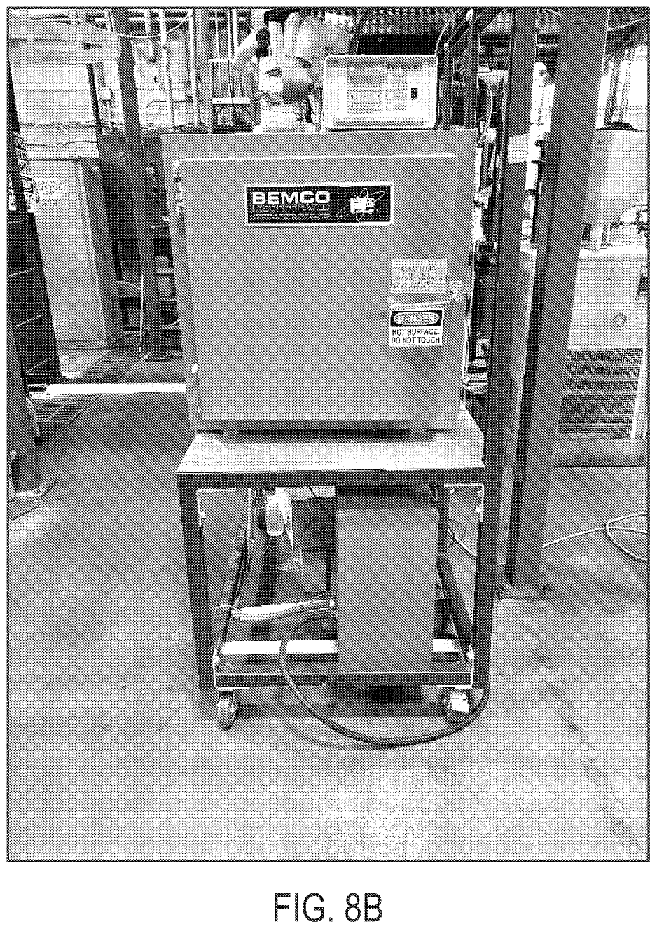

The SW membrane module fabricated was tested with a simulated flue gas containing 20.0/6 CO₂, 48.4% N₂, 15.0% O₂, 16.6% H₂O, 3 ppm SO₂, and 3 ppm NO₂ at 77 °C for about 200 h. The feed and permeate pressures were controlled at 2.5 and 0.8 atm, respectively. This set of conditions was referred to as Conditions \textcircled{1}. Then, the module was tested using a simulated flue gas of the natural gas combined cycle (NGCC) consisting of 4.1% CO₂ for about 400 h (Conditions \textcircled{2}), and a simulated coal-derived flue gas containing 13% CO₂ (Conditions \textcircled{3}) for about 500 h. Under these two simulated flue gases, the feed pressure was increased to 4 atm. The test conditions were then alternated between \textcircled{2} and \textcircled{3} for two cycles, resulting in a total test time of 2000 h. As shown in FIG. 7, the module exhibited an average CO₂ permeance of 4217 GPU and a CO₂/N₂ selectivity of 171 and remained stable for ca. 2000 h, which are believed to be the highest combined permeance/selectivity membrane performance for carbon capture from flue gases. Thus, the fabrication of the commercial-size 8-inch diameter prototype SW membrane module was successful.

### Example 5. Testing of Commercial-Size 8-inch Diameter Prototype SW Module with Polyguanidine-Containing Membrane Using Actual Coal-Derived Flue Gas

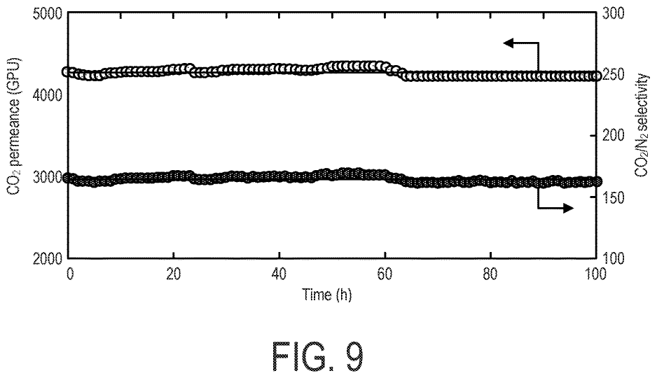

The commercial-size 8-inch diameter SW membrane module as described in Example 3 was also tested with an actual coal flue gas at the Center for Applied Energy Research (CAER) at the University of Kentucky. Ohio bituminous coal was combusted in a 58-kW boiler at CAER, which is shown in FIG. 8A. On average, the coal flue gas contained 9.4% CO₂, 78.5% N₂, 12.1% O₂, 11 ppm SO₂, and 22 ppm NOx, on dry basis, after a flue gas desulfurization unit. This flue gas was then filtered by 5-μm and 1-μm filters, subsequently, to remove the particulate matter. A caustic polisher with 20 wt. % NaOH (aq.) was then used to reduce the SO₂ and NO % concentrations down to <1 ppm. The pre-treated flue gas, which was fully saturated with water vapor at 77 °C and 4-atm feed pressure, was then passed to the membrane testing unit as shown in FIG. 8B. A vacuum of 0.8 atm was pulled on the permeate side

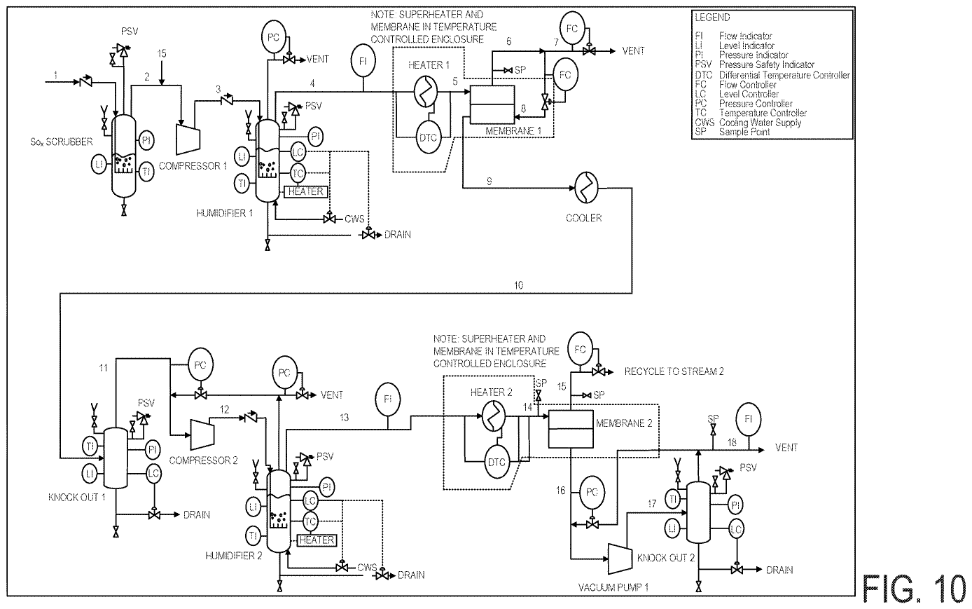

During the 100-h continuous testing with the actual coal flue gas at CAER, the commercial-size 8-inch diameter SW membrane module demonstrated an average CO₂ permeance of 4269 GPU and a CO₂/N₂ selectivity of 165 (FIG. 9). No performance deterioration was observed throughout the test, even though a relatively large fluctuation in the feed CO₂ concentration was observed from the beginning of the test for about 60 hours. Thus, the membrane disclosed in this invention is suitable for decarbonizing the coal flue gas and has potential for future process scale-up.

### Example 6. Bench Skid Testing of the 2-Stage Membrane Process Comprising a Commercial-Size 8-inch Diameter Prototype SW Module with Polyguanidine-Containing Membrane in Stage 1 Countercurrent Operation Using Simulated Coal Flue Gas

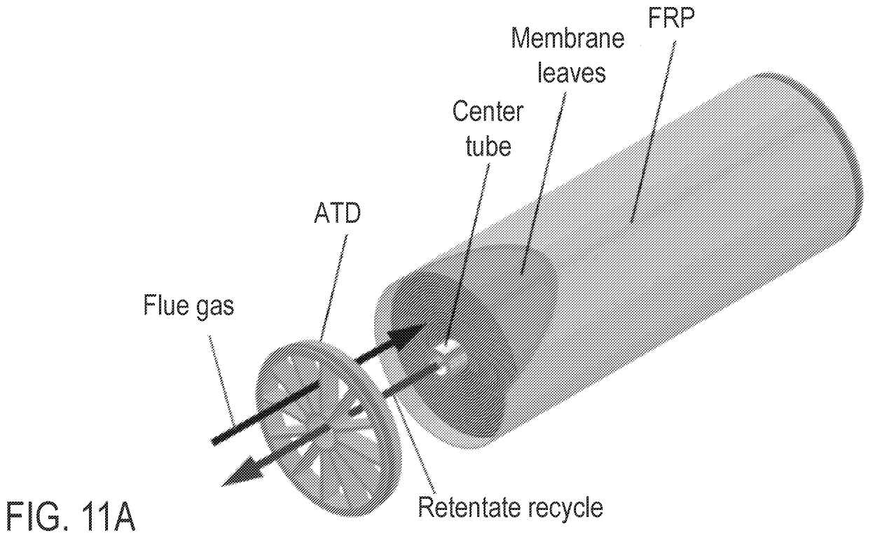

A bench-scale two-stage membrane skid was constructed in this example to demonstrate 90% CO₂ capture from a simulated coal flue gas with >95% CO₂ purity. The piping and instrumentation diagram (P&LD) of the bench skid is shown in FIG. 10. A simulated flue gas slipstream (Stream 1) enters a SO₂ Scrubber containing 20% NaOH aqueous solution in order to polish the SO₂ down to 3 ppm. The pretreated flue gas (Stream 2) is compressed to ca. 3.7 atm by Compressor 1. This stream (Stream 3) enters Humidifier 1, which ensures the flue gas is fully saturated with water vapor at 77 °C. The Humidifier 1 is also connected to a pressure buffer tank with a back pressure regulator, which controls the pressure at 3.6 atm. Compared with the designed feed pressure of 3.5 atm, the 0.1 atm (ca. 1.5 psi) pressure head is to account for the pressure drop in Membrane Module 1 (Stage 1 Module). The pressurized flue gas (Stream 4) is finally conditioned by Heater 1 in case of any heat loss and enters the Membrane Module 1 as feed (Stream 5). On the retentate side of this membrane module (Stream 6), a first mass flow controller recycles a portion of the pressurized retentate as an internal sweep (Stream 8). The remaining retentate is released by a second mass flow controller (Stream 7), which ultimately controls the overall flue gas flow rate. The permeate of this membrane module (Stream 9) contains some moisture from the water permeation. The water content is in excess for Membrane Module 2. Therefore, a portion of the moisture is knocked out by a Cooler (Stream 10) and Knock Out 1 (Stream 11).

Stream 11 is then re-pressurized by Compressor 2 to 3.7 atm (Stream 12), which is cooled to 77 °C and humidified by Humidifier 2 (Stream 13). A pressure buffer tank, i.e., Knock Out 1, is also connected to Humidifier 2 to control the pressure at 3.6 atm. This stream is re-heated by Heater 2 in case of any heat loss (Stream 14) and is fed to Membrane Module 2 (Stage 2 Module). The pressurized retentate (Stream 15) is released by a mass flow controller, which ultimately controls the feed flow rate. This stream is eventually recycled to Stream 2. The permeate (Stream 16) is withdrawn by Vacuum Pump 1 at 0.7 atm. The discharge of the Vacuum Pump 1 (Stream 17) is dehumidified by Knock Out 2 and then released (Stream 18).

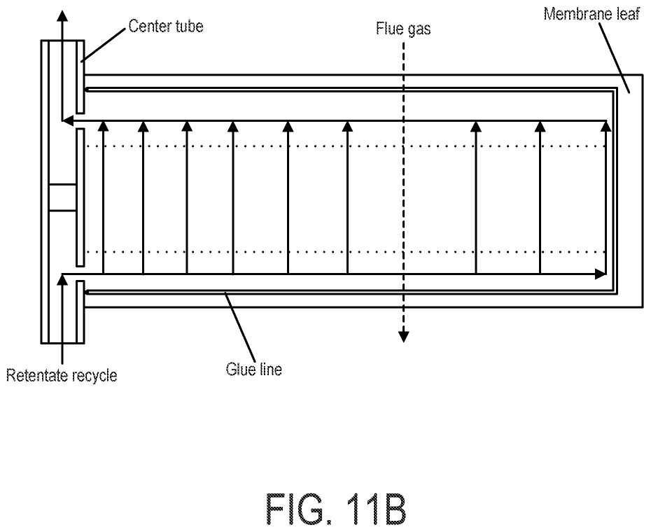

The Stage 1 Module was based on the SW membrane module as described in Example 4, which contained 41 membrane leaves, each with a width of 20 inches and a length of 36 inches, yielding a total membrane area of 35 m². However, in order to use the partially recycled retentate as a sweep gas, a countercurrent configuration was employed as illustrated in FIGS. 11A-11B. The feed gas (i.e., flue gas) entered the SW element through the feed spacers, while the sweep in the retentate recycle operation was firstly passed to the element through the center tube and was then distributed through the permeate spacer. In order to ensure an even distribution of the sweep flow on the permeate side and avoid “dead zones” near the edges of the membrane leaf, an epoxy glue dot line with a strategically designed pattern was developed to decrease the pressure drop and have a countercurrent flow configuration as shown in FIG. 11B. The distance between the glue dot line and the inner glue line of the membrane leaf was set to 1.5″ for the sweep inlet side and 2.5″ for the sweep outlet side to accommodate the additional flow due to the permeate. The diameter of the glue dot was 0.25″. The spacing between two glue dots was set to be 0.5″ for the first 12″ portion of the membrane leaf, 1 inch for the middle 12″ portion of the membrane leaf, and 1.5″ for the last 12″ portion of the membrane leaf in order to achieve a more even distribution of the sweep flow over these 3 portions of the membrane leaf.

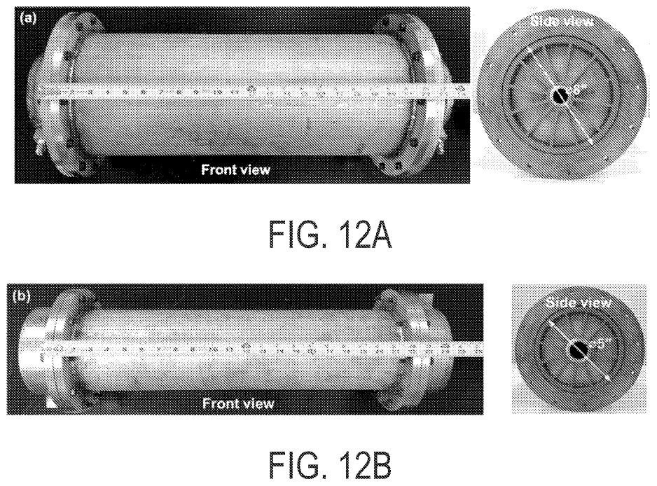

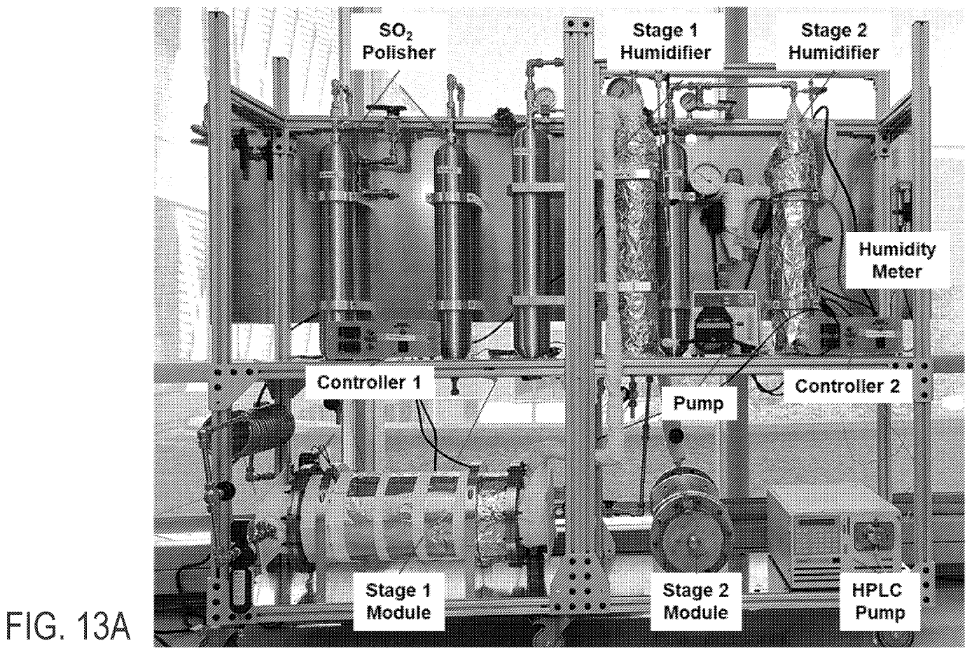

The Stage 2 Module was in a crossflow pattern, which is effectively the same as that in Example 4. However, only 14 membrane leaves were required for this stage, resulting in a total membrane area of 12 m² and thusly a smaller diameter of 5″. The fabricated Stage 1 and Stage 2 Modules are shown in FIGS. 12A-12B. A photo of the integrated bench skid is shown in FIG. 13.

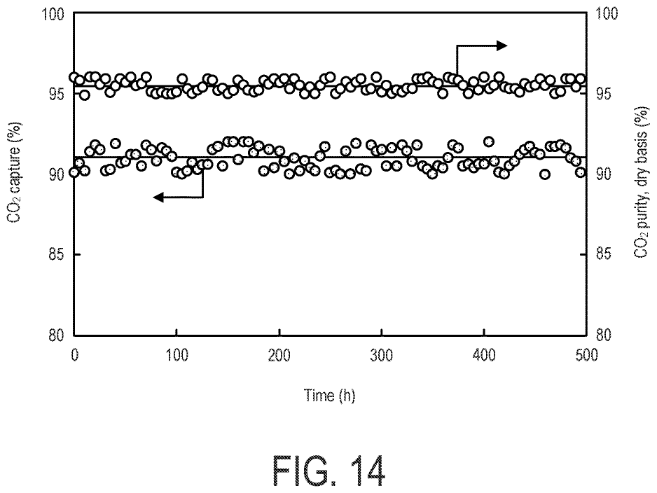

The integrated bench skid was tested with a simulated coal flue gas containing 13.0% CO₂, 55.4% N₂, 15.0% O₂, 16.6% H₂O, 3 ppm SO₂, and 3 ppm NO₂ at 77 °C. As shown in FIG. 14, a CO₂ capture degree of 91.0±0.6% and a CO₂ purity (dry basis) of 95.5±0.3%. The minor components in the CO₂ product included 4.5% N₂, 9 ppm O₂, 13 ppm SO₂, and 11 ppm NO₂, all on dry basis. The concentrations of these minor components met the CO₂ transportation standard through carbon steel pipeline (i.e., 4-5% N₂, <10 ppm O₂, <100 ppm SO₂, and <100 ppm NOx). In the course of 500-h testing, the skid separation performance remained stable. This example has demonstrated not only the good stabilities of both the membrane modules and the 2-stage membrane process, but also the capture targets of both a >90% CO₂ capture degree and a >95% CO₂ purity.

### REFERENCES

[1] International Energy Agency, CO₂ emissions—Global energy review 2021, available at https://www.iea.org/reports/global-energy-review-2021/co2-emissions, accessed 3/1/2022.
[2] V. Andreoni, S. Galmarini, Drivers in CO₂ emissions variation: A decomposition analysis for 33 world countries, Energy, 103 (2016) 27-37.
[3] J. Black, Cost and Performance Baseline for Fossil Energy Plants Volume 1: Bituminous Coal and Natural Gas to Electricity Final report, 2nd ed., National Energy Technology Laboratory, November, 2010.
[4] W. S. W. Ho, K. K. Sirkar, Membrane Handbook, Chapman & Hall, New York, 1992, Kluwer Academic Publishers, Boston, reprint edition, 2001.
[5] Y. Chen, B. Wang, L. Zhao, P. Dutta, W. S. W. Ho, New Pebax®/zeolite Y composite membranes for CO₂ capture from flue gas, J. Membr. Sci., 495 (2015) 415-423.
[6] W. Yave, A. Car, J. Wind, K. V. Peinemann, Nanometric thin film membranes manufactured on square meter scale: Ultra-thin films for CO₂ capture, Nanotechnology. 21 (2010) 395301.
[7] W. Yave, A. Car, S. S. Funari, S. P. Nunes, K. V. Peinemann, CO₂-philic polymer membrane with extremely high separation performance, Macromolecules, 43 (2009) 326-333.
[8] Y. Han, W. S. W. Ho, Recent advances in membranes for CO₂ capture, Chin. J. Chem. Eng., 26 (2018) 2238-2254.
[9] Y. Han, W. S. W. Ho, Polymeric membranes for CO₂ separation and capture”, J. Membr. Sci., 628(2021), 119244.
[10] P. Danckwerts, The reaction of CO₂ with ethanolamines, Chem. Eng. Sci., 34 (1979) 443-446.
[11] Y. Han, D. Wu, W. S. W. Ho, Simultaneous effects of temperature and vacuum and feed pressures on facilitated transport membrane for CO/N₂ separation, J. Membr. Sci., 573 (2019) 476-484.
[12] Y. Han, D. Wu, W. S. W. Ho, Nanotube-reinforced facilitated transport membrane for CO₂/N₂ separation with vacuum operation, J. Membr. Sci., 567 (2018) 261-271.
[13] Y. Chen, W. S. W. Ho, High-molecular-weight polyvinylamine/piperazine glycinate membranes for CO₂ capture from flue gas, J. Membr. Sci., 514 (2016) 376-384.
[14] Y. Chen, L. Zhao, B. Wang. P. Dutta, W. S. W. Ho, Amine-containing polymer/zeolite Y composite membranes for CO₂/N₂ separation, J. Membr. Sci., 497 (2016) 21-28.
[15] Z. Tong, W. S. W. Ho, New sterically hindered polyvinylamine membranes for CO₂ separation and capture, J. Membr. Sci., 543 (2017) 202-211.
[16] T. Y. Chen, X. Deng, L. C. Lin, W. S. W. Ho, New sterically hindered polyvinylamine-containing membranes for CO₂ capture from flue gas, J. Membr. Sci., 64, 120195 (2022).
[17] R. Pang, K. K. Chen, Y. Han, W. S. W. Ho, Highly permeable polyethersulfone substrates with bicontinuous structure for composite membranes in CO₂/N₂ separation, J. Membr. Sci., 612(2020), 118443.
[18] P. Shirley, P. Myles, Quality Guidelines for Energy System Studies: CO₂ Impurity Design Parameters, National Energy Technology Laboratory, January 2019

The compositions, systems, and methods of the appended claims are not limited in scope by the specific compositions, systems, and methods described herein, which are intended as illustrations of a few aspects of the claims. Any compositions, systems, and methods that are functionally equivalent are intended to fall within the scope of the claims. Various modifications of the compositions, systems, and methods in addition to those shown and described herein are intended to fall within the scope of the appended claims. Further, while only certain representative compositions, systems, and method steps disclosed herein are specifically described, other combinations of the compositions, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A membrane comprising:
a support layer; and
a selective polymer layer disposed on the support layer;
wherein the selective polymer layer comprises a polymer matrix comprising a polyguanidine polymer.

2. The membrane of claim 1, wherein the polyguanidine polymer is chosen from polyethylene guanidine, polytrimethylene guanidine, polytetramethylene guanidine, polypentamethylene guanidine, polyhexamethylene guanidine, polyheptamethylene guanidine, polyoctamethylene guanidine, polyethylene N-methylguanidine, polytrimethylene N-methylguanidine, polytetramethylene N-methylguanidine, polypentamethylene N-methylguanidine, polyhexamethylene N-methylguanidine, polyheptamethylene N-methylguanidine, polyoctamethylene N-methylguanidine, polyethylene N,N′-dimethylguanidine, polytrimethylene N,N′-dimethylguanidine, polytetramethylene N,N′-dimethylguanidine, polypentamethylene N,N′-dimethylguanidine, polyhexamethylene N,N′-dimethylguanidine, polyheptamethylene N,N′-dimethylguanidine, polyoctamethylene N,N′-dimethylguanidine, poly(N-vinylguanidine), poly(N-allylguanidine), poly(N-butylguanidine), poly(N-pentylguanidine), poly(N-hexylguanidine), poly(N-heptylguanidine), poly(N-octylguanidine), copolymers thereof, and blends thereof.

3. The membrane of any of claims 1-2, wherein the polyguanidine polymer comprises polyethylene guanidine (PEG).

4. The membrane of any of claims 1-3, wherein the polyguanidine polymer is present in the selective polymer layer in an amount of from 10% to 70% by weight, based on the total dry weight of the selective polymer layer.

5. The membrane of any of claims 1-4, wherein the polymer matrix further comprises a hydrophilic polymer, an amine-containing polymer, or a combination thereof.

6. The membrane of claim 5, wherein the amine-containing polymer is selected from the group consisting of polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

7. The membrane of claim 6, wherein the amine-containing polymer comprises polyvinylamine.

8. The membrane of any of claims 5-7, wherein the hydrophilic polymer comprises a polymer selected from the group consisting of polyvinylalcohol, polyvinylacetate, polyethylene oxide, polyvinylpyrrolidone, polyacrylamine, a polyamine such as polyallylamine, polyvinyl amine, or polyethylenimine, polysiloxane, copolymers thereof, and blends thereof.

9. The membrane of any of claims 1-8, wherein the selective polymer layer further comprises a mobile carrier dispersed within the polymer matrix.

10. The membrane of claim 9, wherein the mobile carrier comprises a guanidine-based mobile carrier, an amine-containing mobile carrier, or a combination thereof.

11. The membrane of any of claims 9-10, wherein the mobile carrier has a molecular weight of less than 1,000 Da.

12. The membrane of any of claims 9-11, wherein the guanidine-based mobile carrier comprises a compound defined by Formula I below 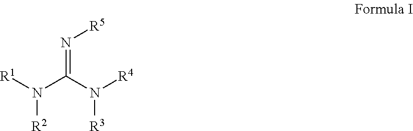
wherein
R¹ and R² are each independently selected from the group consisting of H, C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, wherein said C₁₋₆ alkyl, C₂₋₆ alkenyl, C₂₋₆ alkynyl, C₁₋₄ haloalkyl, C₃₋₁₀cycloalkyl, 6-10 membered aryl, 5-10 membered heteroaryl, and 4-10 membered heterocycloalkyl, are optionally substituted with 1, 2, 3, or 4 independently selected R^{A} groups, or R¹ and R², together with the N atom to which they are attached, form a 4-9 membered heterocycloalkyl group or a 5-6 membered heteroaryl group, each optionally substituted with 1, 2, or 3 independently selected R^{A} groups;
R³ and R⁴ are each independently selected from the group consisting of H, C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, wherein said C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, are optionally substituted with 1, 2, 3, or 4 independently selected R^{A} groups, or R³ and R⁴, together with the N atom to which they are attached, form a 4-9 membered heterocycloalkyl group or a 5-6 membered heteroaryl group, each optionally substituted with 1, 2, or 3 independently selected R^{A} groups;
R⁵ is selected from the group consisting of H, C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, wherein said C₁₋₆ alkyl, C₂₋₆ alkenyl, C₂₋₆ alkynyl, C₁₋₄ haloalkyl, C₃₋₁₀ cycloalkyl, 6-10 membered aryl, 5-10 membered heteroaryl, and 4-10 membered heterocycloalkyl, are optionally substituted with 1, 2, 3, or 4 independently selected R^{A} groups; and
each R^{A} is independently selected from OH, NO₂, CN, halo, C₁₋₆ alkyl, C₂₋₆ alkenyl, C₂₋₆ alkynyl, C₁₋₄ haloalkyl, C₁₋₆ alkoxy, C₁₋₆ haloalkoxy, cyano-C₁₋₃ alkyl, HO—C₁₋₆ alkyl, amino, C₁₋₆ alkylamino, di(C₁₋₆(alkyl)amino, thio, C₁₋₄ alkylthio, C₁₋₆ alkylsulfinyl, C₁₋₆ alkylsulfonyl, carbamyl, C₁₋₆alkylcarbamyl, di(C₁₋₆alkyl)carbamyl, carboxy, C₁₋₆ alkylcarbonyl, C₁₋₆ alkoxycarbonyl, C₁₋₆ alkylcarbonylamino, C₁₋₆ alkylsulfonylamino, aminosulfonyl, C₁₋₆ alkylaminosulfonyl, di(C₁₋₆ alkyl)aminosulfonyl, aminosulfonylamino, C₁₋₆ alkylaminosulfonylamino, di(C₁₋₆ alkyl)aminosulfonylamino, aminocarbonylamino, C₁₋₆ alkylaminocarbonylamino, and di(C₁₋₆ alkyl)aminocarbonylamino.

13. The membrane of claim 12, wherein R¹, R², R³, and R⁴ are all C₁₋₄ alkyl.

14. The membrane of claim 13, wherein R¹, R², R³, and R⁴ are all methyl.

15. The membrane of any of claims 12-14, wherein R⁵ is H.

16. The membrane of any of claims 12-14, wherein R⁵ is C₁₋₆, alkyl optionally substituted with 1, 2, 3, or 4 independently selected R^{A} groups.

17. The membrane of claim 16, wherein R⁵ is C₁₋₆ alkyl substituted with an OH group.

18. The membrane of claim 16, wherein R⁵ is C₁₋₆ alkyl substituted with an amino group.

19. The membrane of any of claims 10-18, wherein the guanidine-based mobile carrier comprises one of the following 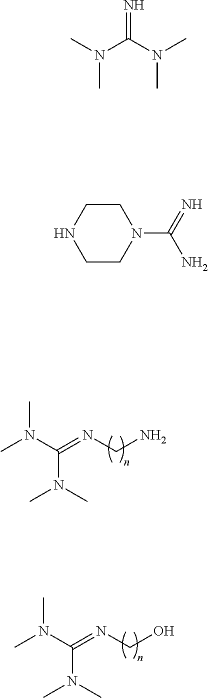
wherein n is an integer from 1 to 12, such as from 1 to 6, TMG is tetramethyguanidine, and PZC is piperazine-1-carboximidamide.

20. The membrane of any of claims 10-19, wherein the guanidine-based mobile carrier is selected from a group comprising tetramethylguanidine, piperazine-1-carboximidamide, or a combination thereof.

21. The membrane of any of claims 10-20, wherein the amine-containing mobile carrier comprises a salt of a primary amine or a salt of a secondary amine.

22. The membrane of any of claims 10-21, wherein the amine-containing mobile carrier compound comprises a salt defined by a general formula below 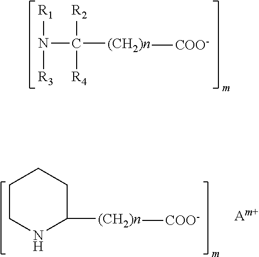
wherein R₁, R₂, R₃, and R₄ are hydrogen or hydrocarbon groups having from 1 to 4 carbon atoms, n is an integer ranging from 0 to 4, and A^{m+} is a cation having a valence of 1 to 3, and m is an integer equal to the valence of the cation.

23. The membrane of any of claims 10-22, wherein the amine-containing mobile carrier comprises a salt selected from the group consisting of aminoisobutyric acid-potassium salt, aminoisobutyric acid-lithium salt, aminoisobutyric acid-piperazine salt, glycine-potassium salt, glycine-lithium salt, glycine-piperazine salt, dimethylglycine-potassium salt, dimethylglycine-lithium salt, dimethylglycine-piperazine salt, piperadine-2-carboxlic acid-potassium salt, piperadine-2-carboxlic acid-lithium salt, piperadine-2-carboxlic acid-piperazine salt, piperadine-4-carboxlic acid-potassium salt, piperadine-4-carboxlic acid-lithium salt, piperadine-4-carboxlic acid-piperazine salt, piperadine-3-carboxlic acid-potassium salt, piperadine-3-carboxlic acid-lithium salt, piperadine-3-carboxlic acid-piperazine salt, and blends thereof

24. The membrane of any of claims 10-23, wherein the amine-containing mobile carrier comprises an amino acid salt.

25. The membrane of claim 24, wherein the amino acid salt is defined by the formula below 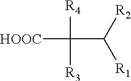
wherein, independently for each occurrence in the amino acid, each of R1, R2, R3 and R4 is selected from one of the following 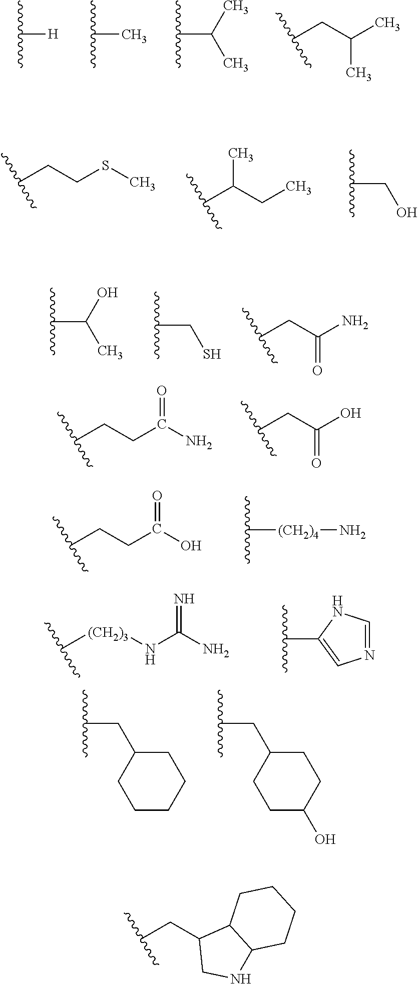
or R₁ and R₃, together with the atoms to which they are attached, form a five-membered heterocycle defined by the structure below when n is 1, or a six-membered heterocycle defined by the structure below when n is 2

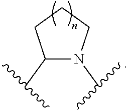

26. The membrane of any of claims 24-25, wherein the amino acid salt comprises a glycinate salt, a sarcosinate salt, or an aminoisobutyrate salt.

27. The membrane of any of claims 1-26, wherein the selective polymer layer further comprises a CO₂-philic ether.

28. The membrane of claim 27, wherein the CO₂-philic ether is chosen from an alcohol ether, a polyalkylene alcohol ether, a polyalkylene glycol, a poly(oxyalkylene)glycol, a poly(oxyalkylene)glycol ether, an ethoxylated phenol, and combinations thereof.

29. The membrane of claim 28, wherein the CO₂-philic ether is an alkyl ethoxylate (C1-C6)-(EO)x, where x=1-30 and the ethoxylate is linear or branched.

30. The membrane of claim 29, wherein the CO₂-philic ether is chosen from ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), poly(ethylene glycol) dimethyl ether, or any combination thereof

31. The membrane of any of claims 1-30, wherein the selective polymer layer further comprises a cross-linking agent.

32. The membrane of claim 31, wherein the cross-linking agent comprises a compound selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, and combinations thereof.

33. The membrane of any of claims 1-32, wherein the selective polymer layer further comprises graphene oxide dispersed within the polymer matrix.

34. The membrane of claim 33, wherein the graphene oxide has a carbon to oxygen ratio of from 3 to 20.

35. The membrane of any of claims 33-34, wherein the graphene oxide has a carbon to oxygen ratio of from 1 to 3.

36. The membrane of any of claims 33-35, wherein the selective polymer layer comprises from 0.01% to 5% by weight graphene oxide, based on the total dry weight of the selective polymer layer.

37. The membrane of any of claims 33-36, wherein the graphene oxide is nanoporous.

38. The membrane of any of claims 1-37, wherein the selective polymer layer further comprises carbon nanotubes dispersed within the polymer matrix.

39. The membrane of any of claims 1-38, wherein the support layer comprises a gas permeable polymer.

40. The membrane of claim 39, wherein the gas permeable polymer comprises a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

41. The membrane of claim 40, wherein the gas permeable polymer comprises polyethersulfone or polysulfone.

42. The membrane of any of claims 1-41, wherein the support layer comprises a gas permeable polymer disposed on a base.

43. The membrane of claim 42, wherein the base comprises a non-woven fabric.

44. The membrane of claim 43, wherein the non-woven fabric comprises fibers formed from a polyester.

45. The membrane of any of claims 1-44, wherein the membrane is configured in a flat sheet, a spiral-wound, a hollow fiber, or a plate-and-frame configuration.

46. The membrane of any one of claims 1-45, wherein the membrane is selectively permeable to an acidic gas.

47. The membrane of any one of claims 1-46, wherein the membrane is selectively permeable to a fluid selected from the group consisting of carbon dioxide, hydrogen sulfide, sulfur dioxide, sulfur trioxide, nitrogen oxide, hydrogen chloride, water, and combinations thereof.

48. The membrane of any of claims 1-47, wherein the selective polymer layer has a CO₂:N₂ selectivity of at least 50 at 57 °C and 4 bar feed pressure.

49. The membrane of any of claims 1-48, wherein the selective polymer layer has a CO₂:N₂ selectivity of from 50 to 500 at 57 °C and 4 bar feed pressure, from 50 to 350 at 57 °C and 4 bar feed pressure, from 100 to 500 at 57 °C and 4 bar feed pressure, or from 100 to 350 at 57 °C and 4 bar feed pressure.

50. A method for separating a first gas from a feed gas stream, the method comprising contacting a membrane defined by any of claims 1-49 with the feed gas stream comprising the first gas under conditions effective to afford transmembrane permeation of the first gas.

51. The method of claim 50, wherein the feed gas comprises hydrogen, carbon dioxide, hydrogen sulfide, hydrogen chloride, carbon monoxide, nitrogen, methane, steam, sulfur oxides, nitrogen oxides, or combinations thereof.

52. The method of any of claims 50-51, wherein the first gas is chosen from carbon dioxide, hydrogen sulfide, hydrogen chloride, and combinations thereof.

53. The method of any of claims 50-52, wherein the feed gas comprises a second gas selected from the group consisting of nitrogen, hydrogen, carbon monoxide, and combinations thereof, and
wherein the membrane exhibits a first gas/second gas selectivity of from 50 to 500 at 57 °C and 4 bar feed pressure.

54. A method of making a membrane comprising depositing a selective polymer layer on a support layer, wherein the selective polymer layer comprises a polymer matrix comprising a polyguanidine polymer.
